(19) United States
(12) Patent Application Publication
(10) Pub. No.: US 2026/0003893 A1
(43) Pub. Date: Jan. 1, 2026

(54) SKILL EXTRACTION PIPELINE

(71) Applicant: AstrumU, Inc., Bellevue, WA (US)

(72) Inventors: Zhanlin Liu, Redmond, WA (US); Xiao Cai, Redmond, WA (US); Yitao Li, Chicago, IL (US)

(21) Appl. No.: 19/183,681

(22) Filed: Apr. 18, 2025

Related U.S. Application Data
(63) Continuation-in-part of application No. 18/768,550, filed on Jul. 10, 2024, now abandoned.
(60) Provisional application No. 63/665,514, filed on Jun. 28, 2024.

(51) Int. Cl. G06F 16/28

(52) U.S. Cl. CPC G06F 16/285

(57) ABSTRACT

Embodiments are directed to managing data for skill extraction pipeline. Skill spans may be determined based on skill information associated with job descriptions such that each skill span includes words included in the skill information. A comparison of the skill spans with other skill spans associated with a skill knowledge graph may be generated. Skill nodes may be generated for the unmatched skill spans. The new skill nodes may be integrated into the skill knowledge graph. Accordingly, the skill graph may be automatically updated for use in job/career applications including report generation.

### CROSS-REFERENCE TO RELATED APPLICATIONS

This application is a Utility Patent application based on previously filed U.S. Provisional Patent Application No. 63/665,514 filed on Jun. 28, 2024. This Utility Patent Application is also a Continuation-in-Part of U.S. patent application Ser. No. 18/768,550 filed on Jul. 10, 2024. The benefit of the filing dates which is hereby claimed under 35 U.S.C. § 119(e) and § 120 and the contents of these applications are herein incorporated by reference in their entirety.

### TECHNICAL FIELD

The present invention relates generally to data management, and more particularly, but not exclusively, to extracting skills or skill information from various data sources.

### BACKGROUND

Identifying persons that make good employees has long been a goal of organizations. And, in today's highly competitive global market, finding and keeping great employees is becoming more challenging. Conventionally, organizations may be forced to rely on narrow or limited criteria derived from anecdotal evidence, personal preferences, gut feelings, or the like, rather than evidence based analytics to determine if a person may be a good employee candidate. Likewise, students or other job seekers may employ ad-hoc methods for selecting education or training to obtain the skills desired by employers to obtain particular employment opportunities. In some cases, skills provided by training programs or educational programs can be an important criteria for identifying which training programs or educational programs may help students or employee candidates obtain their career goals. Accordingly, students may evaluate training programs or educational programs based on the skills they provide. Similarly, in some cases, employers may attempt to identify viable employment candidates based on how well their skills match the skills required or desired for open positions. However, matching skills across different contexts or institutions may be difficult because in some cases different contexts or institutions may use different skill names or skill descriptions. Accordingly, using skills as a criteria for matching students with education programs or matching job seekers with employment opportunities may be disadvantaged by mismatches in skill names or skill descriptions. Further, skills may be continuously evolving such that new skills may be encountered. Recognizing such skills and including them in skill matching programs may require significant manual intervention. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical schematic of a system for skill extraction pipelines in accordance with one or more of the various embodiments;

FIG. 5 illustrates a logical schematic of a pipeline for skill extraction pipelines in accordance with one or more of the various embodiments;

FIG. 6 illustrates a logical schematic of a system that may be portion of a skill extraction pipeline in accordance with one or more of the various embodiments;

FIG. 7 illustrates a logical schematic of a system that may be portion of a skill extraction pipeline in accordance with one or more of the various embodiments;

FIG. 8 illustrates a logical schematic of a system that may be portion of a skill extraction pipeline in accordance with one or more of the various embodiments;

FIG. 9 illustrates a logical schematic of a skill graph portion for skill extraction pipelines in accordance with one or more of the various embodiments;

FIG. 10 illustrates a logical schematic of a portion of a skill graph for skill extraction pipelines in accordance with one or more of the various embodiments;

FIG. 11 illustrates a logical schematic of a portion of a skill graph for skill extraction pipelines in accordance with one or more of the various embodiments;

FIG. 12 illustrates an overview flowchart of a process for skill extraction pipelines in accordance with one or more of the various embodiments;

FIG. 13 illustrates a flowchart of a process for skill extraction pipelines in accordance with one or more of the various embodiments;

FIG. 14 illustrates a flowchart of a process for skill extraction pipelines in accordance with one or more of the various embodiments;

FIG. 15 illustrates a flowchart of a process for skill label normalization for skill extraction pipelines in accordance with one or more of the various embodiments;

FIG. 16 illustrates a flowchart of a process for skill extraction pipelines in accordance with one or more of the various embodiments;

FIG. 17 illustrates a flowchart of a process for collecting and applying telemetry information and telemetry metrics for skill extraction pipelines in accordance with one or more of the various embodiments;

FIG. 18 illustrates a logical schematic of a prompt for skill extraction pipelines in accordance with one or more of the various embodiments; and

FIG. 19 illustrates a logical schematic of a system for skill extraction pipelines in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein the term “data source” refers to a service, system, or facility that may provide data to a data ingestion platform. Data sources may be local (e.g., on premises databases, reachable via a local area network, or the like) or remote (e.g., reachable over a wide-area network, remote endpoints, or the like). In some cases, data sources may be streams that provide continuous or intermittent flows of data to a data ingestion platform. Further, in some cases, data sources may be local or remote file systems, document management systems, cloud-based storage, or the like. Data sources may support one or more conventional or customer communication or data transfer protocols, such as, TCP/IP, HTTP, FTP, SFTP, SCP, RTP, or the like. In some cases, data sources may be owned, managed, or operated by various organizations that may provide data to a data ingestion platform. In some instances data sources may be public or private websites or other public or private repositories that enable third parties to access hosted content.

As used herein the term “raw data” refers to data provided by a raw data source. Raw data may include structured or unstructured data, documents, streams, or the like. Provided data may be considered as raw because the data source may provide the data in a form or format “as-is.”

As used herein the term “job” refers to a specific role or position that an individual performs in exchange for compensation or other consideration. Jobs typically involve a set of tasks, responsibilities, or duties that may contribute to the functioning of an organization, business, or industry. Jobs may vary significantly in terms of skill level, education requirements, working conditions, required skills, or remuneration.

As used herein the terms “job description,” or “job information” refer to a text based narrative that describes skill requirements, education requirements, responsibilities, activities, or the like, associated with one or more jobs, employment opportunities, occupations, or the like. Note, there may be other sources of similar information such as training descriptions, course descriptions, or the like, that describe skills, activities, responsibilities, requirements, or the like, that may be associated with a particular training program or course work. In the interest of brevity or clarity, herein the term job description should be interpreted to generally represent a text description that describes one or more of features, characteristics, responsibilities, skills, activities, or the like, associated with a particular job offering, training course, military occupational specialty, certification program, or the like.

As used herein the term “skill” refers to abilities or expertise that may be performed for a job, learned from training, taught by a course, or the like.

As used herein, the term “skill span” refers to words, phrases, sentence fragments, or the like, that may be associated with or descriptive of skills. Skill spans may be determined from natural language sources, such as job descriptions, course descriptions, training descriptions, resumes, syllabuses, or the like. In some cases, multi-word skill spans may include words that are near to each other in the source document.

As used herein the term “job profile” refers to one or more data structures or records gathered together to provide information about a job. For example, a job profile may include (or reference) various job description information, required skills, optional skills, or the like. As used herein the terms “job seeker,” “learner,” or “candidate employee” refer to a person that may have applied to job or a person that may be being considered for a job. Learners may be considered students or trainees while job seekers may be persons seeking a one or more particular jobs.

As used herein the term “learner profile” refers to one or more data structures or records gathered together to provide information about a student or job seeker. For example, a learner profile may include (or reference) various information, such as, soft skills, hard skills, verified educational history, verified employment history, short term learning/employment goals, long term learning/employment goals, demographic data, or the like. For example, interpersonal or behavioral skills (e.g., soft skills) associated with courses completed by a learner may be included in the learner's learner profile. For brevity, persons/users who are seeking jobs or otherwise under consideration for job, such as job seekers, employment candidates, students, or the like, may be referred to as learners such that their information may be collected or stored in learner profiles.

As used herein the term “skill extraction model” refers one or more data structures that encapsulate the data, rules, machine learning models, machine learning classifiers, heuristics, or instructions that may be employed to determine skill spans from natural language skill information.

Skill extraction models may include various components, such as, one or more machine learning based classifiers, heuristics, rules, pattern matching, conditions, or the like, that may be employed to determine skill spans that may be included in natural language description. In some cases, skill extraction models may provide confidence scores that represent the quality of the predicted skill spans. In some cases, skill engines may employ one or more skill extraction models to determine skill spans from incoming raw data assets. For example, skill extraction models may be employed to determine skill spans from portions of documents, or the like.

As used herein the term “skill node retrieval and generation model” refers one or more data structures that encapsulate the data, rules, machine learning models, machine learning classifiers, heuristics, or instructions that may be employed to fit skills into a skill knowledge graph (skill graph). Skill retrieval and generation models may include various components, such as, one or more machine learning based classifiers, heuristics, rules, pattern matching, conditions, or the like, that may be employed to determine if skill spans may be associated with existing skill nodes or if new skill nodes should be generated. Skill retrieval and generation models may include instructions, rules, heuristics, or the like, for creating edges that connect skill nodes based on declared criteria. In some cases, Skill retrieval and generation models may be configured to update one or more metrics or attributes that may be associated with skill nodes or edges in a skill graph. Also, skill retrieval and generation models may be employed to determine skill labels based on one or more skill spans or other skill information.

As used herein the term “graph fitting model” refers to one or more data structures that encapsulate the data, rules, machine learning models, machine learning classifiers, heuristics, or instructions that may be employed to fit skills into a skill knowledge graph (skill graph). In some cases, Graph fitting models may be considered components of skill node retrieval and generation gmodels. In some cases, skill node retrieval and generation models may be referred to as graph fitting models if they are being used to map skill nodes or skill relationships to skill graphs.

As used herein the term “skill label model” refers to one or more data structures that encapsulate the data, rules, machine learning models, machine learning classifiers, heuristics, or instructions that may be employed to determine skill labels based on skill spans of other skill information. In some cases, skill label models may be considered components of skill node retrieval and generation models. In some cases, skill node retrieval and generation models may be referred to as skill label models if they are being used to predict labels for skill nodes.

As used herein the term “embedding model” refers to one or more data structures that encapsulate the data, libraries, interfaces, rules, heuristics, or instructions that may be employed to generate embedding vectors for skill spans. In some cases, embedding models may be configured to employ one or more conventional embedding methods or one or more custom embedding methods.

As used herein the term “verification model” refers one or more data structures that encapsulate the data, rules, machine learning models, machine learning classifiers, heuristics, or instructions that may be employed to verify that a predicted skill label is suitable. Verification may include submitting predicted skill labels to one or more authoritative skill information data sources. Verification models may include various components, such as, one or more machine learning based classifiers, heuristics, rules, pattern matching, conditions, or the like, that may be employed to determine verify if predicted skill labels are regularly employed in particular contexts, such as, particular industries, geographic regions, or the like.

As used herein, the terms “large language model,” “generative artificial intelligence model,” “generative AI model” refer to data structures, programs, or the like, that may be trained or designed to perform a variety of natural language processing tasks. Typically, generative AI models may generate text responses in response to text based prompts. Often, generative AI models may be considered to be neural networks that have been trained on large collections of natural language source documents. Accordingly, in some cases, generative AI models may be trained to generate predictive responses based on provided prompts. Prompts may include context information, examples, or the like, that may enable generative AI models to generate responses directed to specific queries or particular problems that go beyond conventional NLP.

As used herein, the term “prompt” refers to one or more data structures that contain or represent prompt information that may be provided to generative AI models. Context information included in prompts may be considered to retrain generative AI models in realtime for answering questions included in the prompts.

As used herein the term “configuration information” refers to information that may include rule based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing data for skill extraction pipeline. In one or more of the various embodiments, a plurality of skill spans may be determined based on skill information associated with one or more job descriptions such that each skill span includes one or more words included in the skill information.

In one or more of the various embodiments, a comparison of the plurality of skill spans with a plurality of other skill spans may be generated such that each of the other skill spans may be associated with a skill node in a skill graph.

In one or more of the various embodiments, an indication by the comparison that one or more skill spans of the plurality of skill spans are unmatched with the plurality of other skill spans may be employed to perform further actions, including: employing a skill label model to generate one or more skill labels based on the one or more unmatched skill spans; employing a verification model to verify the one or more skill labels based on one or more authoritative sources such that the skill label model may be retrained with the one or more skill labels that may be unverifiable; employing the retrained skill label model to generate one or more updated skill labels that may be verified by the verification model; generating one or more new skill nodes based on the one or more verified updated skill labels; generating information for fitting the one or more new skill nodes in the skill graph such that one or more prompts that include the information may be used to train a generative artificial intelligence model to generate an updated skill graph that includes the one or more new skill nodes.

In one or more of the various embodiments, a user interface may be generated for a report that includes one or more display panels with content that is dynamically transformed and arranged for display to a user based on user telemetry, user feedback and telemetry metrics such that the content includes information associated with the updated skill graph and one or more of a control, a result, a graph, a list associated with the skill information, or the like.

In one or more of the various embodiments, the updated skill graph may be employed to generate one or more reports based on one or more queries that are associated with the skill information.

In one or more of the various embodiments, verification of the one or more skill labels may include employing the one or more skill labels to query the one or more authoritative sources such that the one or more authoritative sources include one or more of a general purpose search engine, a labor specific data source, an industry online journal, a government reference, an occupational information database, or the like.

In one or more of the various embodiments, generating the one or more skill labels may include: generating one or more prompts for one or more generative artificial intelligence models such that the one or more prompts may include the one or more unmatched skill spans; training the one or more generative artificial intelligence models with the one or more prompts to determine one or more the skill labels based on one or more responses from the one or more generative artificial intelligence models; or the like.

In one or more of the various embodiments, the skill graph may be generated based on a plurality of skill nodes such that each skill node may be associated with a skill label and one or more skill attributes that include one or more of a reference to a skill span, a reference to a raw data source, a reference to learner profile, a reference to a job profile, a reference to a course profile, or the like. In one or more of the various embodiments, one or more relationships may be determined between the plurality of skill nodes such that each relationship is an edge in the skill graph and such that at least one relationship may be represented by a directed edge that corresponds to one or more actions that enable an acquisition of a target skill.

In one or more of the various embodiments, generating the one or more skill labels may include: determining one or more skill dialects based on the skill information or a query such that each skill dialect may be associated with one or more of a labor market, an industry, a training environment, a career field, a geographic region, or the like; generating one or more prompts for a generative artificial intelligence model based on one or more of the one or more unmatched skill spans or the skill information such that the one or more prompts directs the generative artificial intelligence model to conform the one or more skill labels to the one or more skill dialects; determining the skill labels based on one or more responses from the one or more generative artificial intelligence models; or the like.

In one or more of the various embodiments, verifying the one or more skill labels, may include: generating one or more prompts for a generative artificial intelligence model based on one or more of the one or more unmatched skill spans or the skill information such that the one or more prompts direct the generative artificial intelligence model to verify that the one or more skill labels are consistent with the skill information; determining the one or more verified skill labels based on one or more responses from the generative artificial intelligence model; or the like.

In one or more of the various embodiments, comparing the plurality of skill spans with the plurality of other skill spans may include; generating a plurality of embedding vectors based on the plurality of skill spans such that each embedding vector corresponds to a skill span; comparing the plurality of embedding vectors with a plurality of other embedding vectors such that each of the other embedding vectors may be associated with a skill node in the skill graph; or the like.

In one or more of the various embodiments, retraining the skill label model may include: generating one or more prompts for a generative artificial intelligence model based on one or more unverified skill labels and one or more of the one or more unmatched skill spans or the skill information; retraining the skill label model based on a submission of the one or more prompts; or the like.

### Illustrated Operating Environment

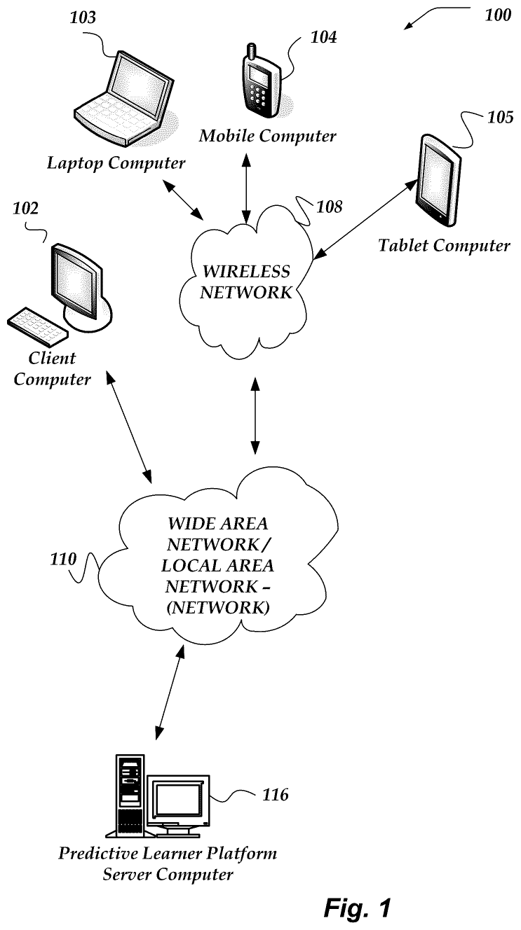

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client computers 102-105, predictive learner platform server computer 116, or the like.

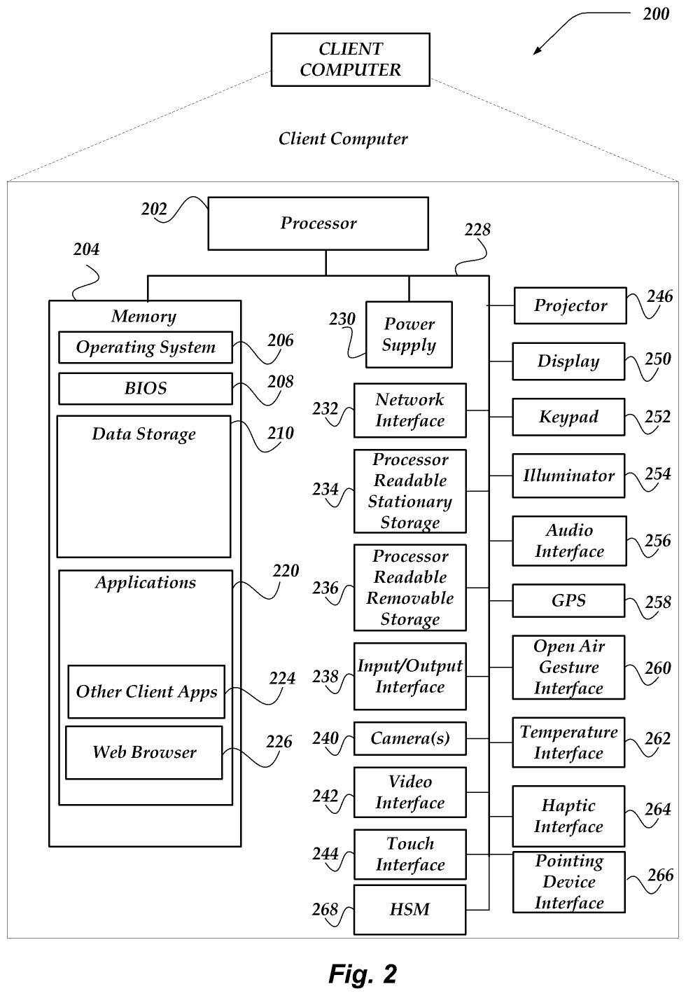

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), extensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, predictive learner platform server computer 116, or other computers.

Client computers 102-105 may further be configured to include a client application that enables an end-user to log into an end-user account that may be managed by another computer, such as ingestion platform server computer 116, profile correlation server computer 118, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by predictive learner platform server computer 116, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division

Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, predictive learner platform server computer 116, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

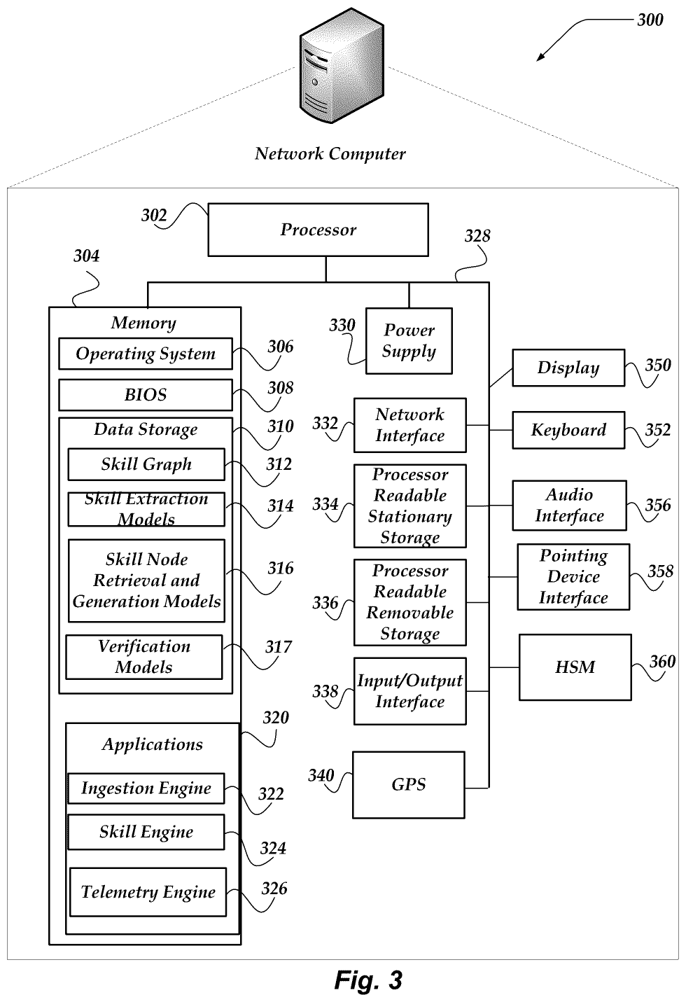

Also, one embodiment of predictive learner platform server computer 116 are described in more detail below in conjunction with FIG. 3. Although FIG. 1 illustrates predictive learner platform server computer 116 as a single computer, the innovations or embodiments are not so limited. For example, one or more functions of predictive learner platform server computer 116 may be distributed across one or more distinct network computers. Moreover, in one or more embodiments, predictive learner platform server computer 116 may be implemented using a plurality of network computers. Further, in one or more of the various embodiments, predictive learner platform server computer 116, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiments of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen. Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over networks implemented using WiFi, Bluetooth™, Bluetooth LTETM, and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, other client applications 224, web browser 226, or the like. Client computers may be arranged to exchange communications with one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one or more embodiments of a predictive learner platform server computer 116, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, ingestion engine 322, skill engine 324, telemetry engine 326, or the like, may be arranged to employ geo-location information to select one or more localization features, such as, time zones, languages, currencies, currency formatting, calendar formatting, or the like. Localization features may be used in user interfaces, dashboards, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux® or a specialized operating system such as Microsoft Corporation's Windows® operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, friend lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, skill graphs 312, skill extraction models 314, skill node retrieval and generation models 316, verification models 316, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include ingestion engine 322, skill engine 324, telemetry engine 326, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, ingestion engine 322, skill engine 324, telemetry engine 326, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to ingestion engine 322, skill engine 324, telemetry engine 326, or the like, may be provisioned and de-commissioned automatically.

Also, in one or more of the various embodiments, ingestion engine 322, skill engine 324, telemetry engine 326, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a

CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

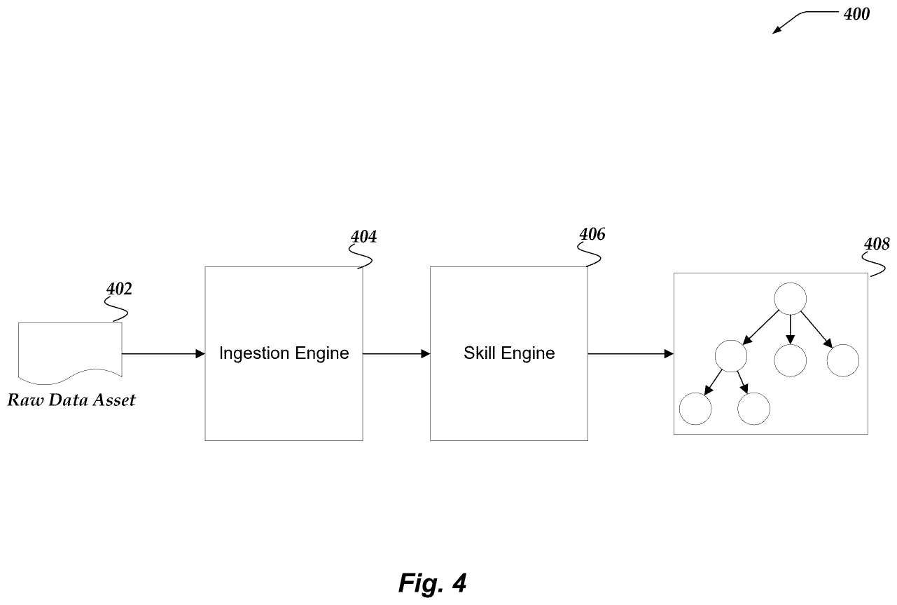

FIG. 4 illustrates a logical schematic of system 400 for skill extraction pipelines in accordance with one or more of the various embodiments. In some embodiments, system 400 may be arranged to receive a raw data asset, such as, raw data asset 402. In some embodiments, raw data assets may be collected or otherwise pre-processed by ingestion engines, such as ingestion engine 404. One of ordinary skill in the art will appreciate that ingestion engine 404 may represent one or more processes or facilities that intake raw data and prepare the raw data for analysis by skill engines, such as skill engine 406. For brevity and clarity, detailed descriptions of the various components or operations that may be considered part of ingestion engine 404 are omitted here.

In some embodiments, raw data may include documents that include information associated with skills or skill descriptions (e.g., skill documents). Accordingly, in some embodiments, raw data assets may include job descriptions, training goal descriptions, educational course descriptions, certificate requirements, resumes, work histories, training histories, transcripts, or the like. In some embodiments, raw data assets may be one or more entries included in government occupational indexes, college course catalogs, commercial industry job reports, or the like. For brevity and clarity, the various types or sources that include skill information may be referred herein as skill descriptions, skill information, or skill documents.

In some cases, raw data assets that include job descriptions may be opaque documents that require optical character recognition (OCR) to convert the raw asset into a format suitable for further analysis. For example, in some embodiments, raw data assets may include scanned documents (e.g., opaque PDFs), images, or the like that may need OCR to enable further analysis. Also, in some embodiments, it may be advantageous to reformat raw data assets into other formats before providing the skill descriptions to skill engines. For example, in some embodiments, ingestion engines may be configured convert documents from conventional office document formats to other formats that may omit format information, style information, meta-data, or the like that may be unneeded or otherwise irrelevant for skill extraction pipelines. Accordingly, in some embodiments, ingestion engines may be arranged to provide skill information to skill engines prepared for subsequent analysis. For example, in some embodiments, raw data assets may be referred to as raw skill information or skill information. Generally, this raw skill information may be a portion of natural language text that include descriptive information associated with skills or skill related activities.

Also, in some embodiments, ingestion engines may be arranged to automatically pull raw data assets from various repositories. For example, in some embodiments, ingestion engines may be integrated with job listing services, career counseling center systems, resume hosting services, government agencies, employment security agencies, corporate recruiting serves, training/educational organizations, or the like. In some embodiments, such integration may enable skill engines to automatically ingest raw data that includes skill information.

Note, in some embodiments, ingestion engines may be enabled to be adaptable to support additional raw data asset types, document formats, or the like that may be encountered. Accordingly, in some embodiments, one of ordinary skill in the art will appreciate that ingestion engines may be flexible systems that enable various raw data formats to be translated into skill description documents (e.g., skill information) that may be consumed by skill engines. Thus, in some cases, for some embodiments, ingestion engines may be arranged to employ libraries, parsers, formatters, classifiers, interpreters, or the like provided via configuration information to account for local requirements or local circumstances.

In some embodiments, skill engines, such as skill engine 406 may be arranged to evaluate or analyze job descriptions or skill descriptions. In some embodiments, skill engines may be arranged to employ skill extraction models to identify skill information from skill documents. In some embodiments, skill extraction models may include heuristics, natural language processing (NLP), machine-learning classifiers, or the like, for determining which skills may be included in skill documents.

Also, in some embodiments, skill engines may be arranged to employ skill node retrieval and generation models for generating, updating, or evaluating skill knowledge graphs, such as skill graph 408. In some embodiments, skill node retrieval and generation models may include or incorporate one or more skill label models or one or more graph fitting models. In some embodiments, skill label models may be employed for predicting skill names to use as skill graph node labels. And, in some embodiments, graph fitting models may be employed for fitting skill nodes into skill graphs. In some cases, for some embodiments, skill node retrieval and generation models may be referred to as skill label models or graph fitting models depending on the role it may be performing.

Further, in some embodiments, skill engines may be arranged to employ generative AI or large language models in skill extraction pipelines. In some cases, for some embodiments, instructions or rules for employing generative AI may be embedded or include in particular skill extraction models. Similarly, in some embodiments, particular prompts or prompt templates may be included or references by skill extraction models. Further, in some embodiments, two or more of skill extraction models may be employed in sequence such that particular skill extraction models may be selectively included in the skill extraction pipeline depending on one or more characteristics of the raw data asset. Likewise, in some embodiments, one or more skill extraction models may be selectively included in skill extraction pipelines depending on the source of the raw data asset. For example, in some embodiments, one or more skill extraction models selected for a skill extraction pipeline may be specialized for processing resumes while other skill extraction models included in a pipeline may be selected for processing course syllabuses, and so on.

In some embodiments, skill engines may be arranged to examine or evaluate skill information extracted from raw data assets. In some embodiments, skill engines may be arranged to generate or update skill graphs, such as skill graph 408. In some embodiments, skill graphs, such as skill graph 408 may be considered graph data structures or graph-like data structures that represent various skills and relationships between skills. Accordingly, in some embodiments, skill engines may be arranged to include extracted skills or related skill information in skill graphs. In some cases, for some embodiments, skills determined from processed raw data assets may be included in a unified or universal skill graphs.

Note, in one or more of the various embodiments, predictive learner platforms may include one or more data stores of job profiles, learner profiles, job seeker profiles, course profiles, or the like, that include information associated with various entities associated with jobs, courses, users, students, employers, or the like. In some embodiments, ingestion engines or other components of learner platforms (not shown) may be arranged to collect various information about the different entities and store them in their respective profile data structures that in turn may be stored in data stores. For example, in some embodiments, skills determined or extracted from resumes, transcripts, training history, work history, or the like, may be associated with job seeker profiles or learner profiles. Likewise, in some embodiments, for example, skills determined or extracted from job descriptions, job offerings, or the like, may be included in employer profiles. Also, for example, in some embodiments, skills determined or extracts from course information, training information, syllabuses, or the like, may be included in course profiles, educational organization profiles, or the like. In general, profiles may be used in reports, interactive reports, applications, job/career analysis, job matching, training planning, or the like. In some embodiments, learner platforms may be configured to leverage skill graphs to improve career/training/education analysis performed by various applications not depicted in detail herein.

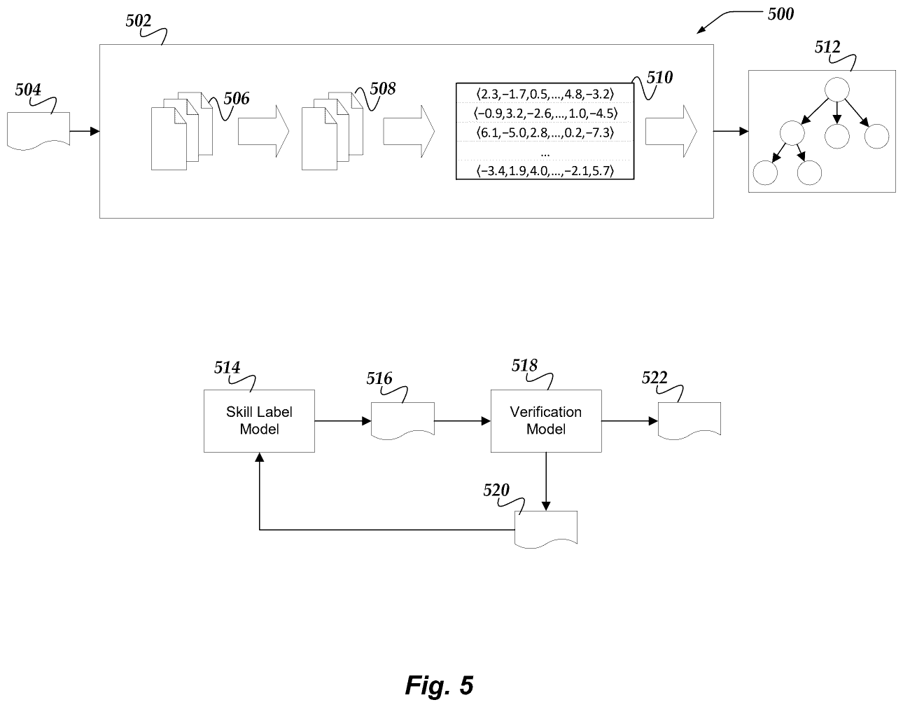

FIG. 5 illustrates a logical schematic of pipeline 500 for skill extraction pipelines in accordance with one or more of the various embodiments. In some embodiments, skill engines, represented here by skill engine 502, may be provided raw data 504 that may include skill information. In this example, raw data 504 may have been processed by an ingestion engine (not shown) or otherwise pre-processed into a machine readable text format.

In some embodiments, raw data provided to engine 502 may include natural language text documents or document sections that may include skill information. In some embodiments, skill information may be included in job descriptions, course descriptions, or the like. Accordingly, in some embodiments, one or more upstream services (e.g., ingestion engines) may employ NLP, document format information, meta-data, document analysis, or the like, to determine one or more portions of documents (raw data) that may include sentences, paragraphs, phrases, or the like, that may be associated with jobs, job description, course descriptions, certifications, training programs, or the like. Accordingly, in some embodiments, raw data may include text predicted to be associated with skill information.

In some embodiments, data 506 may be considered to be natural language text that may be associated with skills. In some embodiments, this text may be taken from job descriptions, course information, or the like, as described above. Accordingly, in some embodiments, skill engines may be arranged to process the natural language text using one or more skill extraction models to determine skill spans that include one or more words associated with one or more skills or skill associated activities. In some embodiments, skill extraction models may be arranged to select words for membership in skill spans based on various NLP heuristics, including location in the text (nearness), word recognition, language use (e.g., connecting prepositions), or the like. In some embodiments, skill engines may be arranged to enable organizations to develop additional heuristics or grouping models that may be included as skill extraction models in a skill span pipeline.

Accordingly, in some embodiments, the particular instructions, rules, or the like, for generating skill spans (skill extraction models) may be determined via configuration information to account for local requirements or local circumstances. In this example, data 508 may be considered to be the skill spans determined from data 506. In some embodiments, skill extraction models may encapsulate data, rules, instructions, machine-learning classifiers, NLP processing, or the like, used for determining skill spans from text-based skill information.

In some embodiments, skill engines may be arranged to generate machine-learning embeddings (embedding vectors) for the skill spans. In some embodiments, various embedding strategies may be employed including conventional strategies such as using word2vec or similar strategies. Also, in some embodiments, skill extraction pipelines may be arranged to enable the particular embedding strategy to be easily substituted. Accordingly, in some embodiments, embedding strategies may be developed or evaluated and then included in the skill extraction pipeline absent disruption to the overall system. In some embodiments, skill extraction pipelines may be arranged to enable more than one embedding strategy to be used parallel to enable real-time comparison of the different embedding strategies. In some embodiments, embedding models may encapsulate the instructions or actions for generating embedding vectors from skill spans.

In some embodiments, skill engines may be arranged to map skill embeddings to skill graphs (e.g., skill knowledge graphs) based on the embedding values. Accordingly, in some embodiments, skill engines may be arranged to incorporate skill information from raw data 504 into skill graphs, such as skill graph 512. Thus, in some embodiments, skill engines, or the like, may employ the skill graphs to evaluate jobs, job seekers, training programs, or the like, using a consistent or normalized view of the associated skills. In some embodiments, graph fitting models may be configured to encapsulate the data, actions, instructions, or the like used for fitting skills or skill spans into skill graphs.

In some embodiments, skill engines may be arranged to employ skill label models to predict skill labels for new skills or skills that may be unmatched in the skill graph. Accordingly, in some embodiments, skill engines may employ one or more skill label models to predict one or more skill labels for skill spans that remain unmatched with skills in the skill graph. In some embodiments, skill engines may be arranged to via skill label models to generate prompts for submission to generative AI models. Accordingly, in some embodiments, the prompts may be specialized to enable generative AI models to predict skill labels based on one or more of skill spans, skill information, or the like, or combination thereof.

In some cases, for some embodiments, skill engines may be arranged to employ skill label models to predict skill labels for difference skill dialects. Accordingly, in some embodiments, specialized prompts may be generated to direct generative AI models to predict skill labels for a particular skill dialect.

In some embodiments, skill engines may be arranged to verify predicted skill labels to ensure that the predicted skill labels may be used in particular contexts, such as, particular industries, geographic regions, particular educational circumstances, or the like. Accordingly, in some embodiments, skill engines may be arranged to employ one or more verification models that encapsulate one or more instructions, rules, or the like for verifying skill label. In some embodiments, skill engines may be arranged to generate via verification models one or more prompts for submission to generative AI models to verify that predicted skill label may be suitable.

In some embodiments, skill engines may be arranged to retrain skill label models based on the results of verification. Accordingly, in some embodiments, unmatched or otherwise unsuitable skill label predictions may be monitored or tracked for use in retraining. In some embodiments, skill label models may be retrained immediately if unsuitable skill labels are predicted. Accordingly, in some embodiments, skill engines may be arranged to modify or update skill label prediction prompts to include skill labels that were determined to be unsuitable.

In this example, for some embodiments, skill label model 514 represents a skill label model that skill engines may employ to predict one or more skill labels, such as predicted skill labels 516. Accordingly, in some embodiments, skill engines may be arranged to employ verification models, such as verification model 518 to verify if predicted skill labels 516 may be suitable for using as skill labels in skill graphs. Accordingly, in some embodiments, unverified skill labels, such as unverified skill labels 520 may be identified and used for retraining skill label models. In some embodiments, verified skill labels, such as verified skill labels 522 may be provided for use in skill graphs.

For example, in some embodiments, skill label models may include instructions for generating a prompt that includes the source skill information, dialect information (e.g., target skill dialect), or the like. Also, in some embodiments, skill label models may provide a set of verified or unverified skill labels to retrain the skill label model to provide improved predictions.

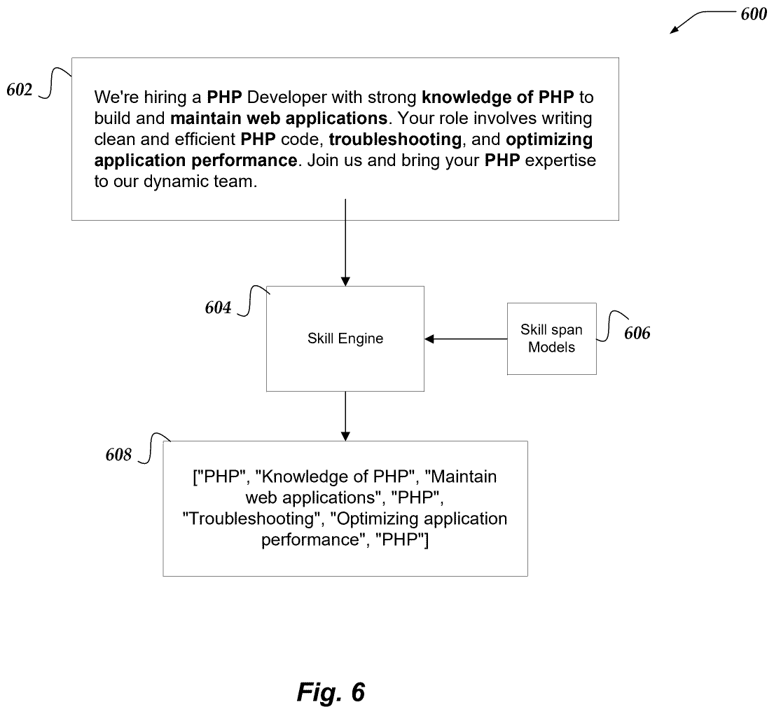

FIG. 6 illustrates a logical schematic of system 600 that may be portion of a skill extraction pipeline in accordance with one or more of the various embodiments. In some embodiments, skill engines may be arranged to transform natural language descriptions that include skill information into skill spans. Accordingly, in some embodiments, data 602 that may include natural language skill descriptions into data 608 that includes one or more skill spans determined from the skill descriptions in data 602.

Accordingly, in some embodiments, skill engines, such as skill engine 604 may be arranged to employ one or more skill extraction models, such as skill extraction models 608 for determining skill spans from natural language skill descriptions. In some embodiments, skill extraction models may include one or more NLP methods, heuristics, classifiers, instructions, rules, or the like, for generating skill spans from natural language skill descriptions. In this example, data 602 may be considered to represent skill description language that may be associated with a job description, or the like.

In some embodiments, skill engine 604 may be arranged to employ skill extraction models 608 to determine skill spans from data 602. In some embodiments, skill engines may be arranged to evaluate sentences or sentence groups that may be included in data, such as data 602 to determine if they may be associated with skill information. Accordingly, in some embodiments, one or more skill extraction models or one or more portions of skill extraction models may be configured to exclude sentences that omit words that may be associated skill information. In some embodiments, skill engines may be arranged to employ skill word dictionaries, knowledge graphs, or the like, for determining if a sentence may include skill words. Also, in some embodiments, one or more skill extraction models or one or more portions of skill extraction models may be arranged to perform sentiment analysis of sentences to predict which sentences may be associated skill information or otherwise include skill span candidates.

In some embodiments, one or more skill extraction models may be trained to recognize sentences that may include skill information or skill words. Accordingly, in some embodiments, skill extraction models may include machine-learning classifiers that have been trained to recognize sentences or sentence groups (paragraphs) that include skill information. In some cases, for some embodiments, skill extraction models may be arranged to include rules or wordlists that may be employed to identify or predict if sentences include skill information.

In some embodiments, skill extraction models may be configured to execute a sequence of conventional NLP operations including, removing stop words, identifying skill associated words, or the like, as part of the skill span prediction. In some embodiments, skill extraction models may be configured to employ word windows that may be applied to sentences included in the natural language skill descriptions.

In this example, for some embodiments, data 608 represents a data structure that includes skill spans determined from data 602. In this example, for some embodiments, data 608 may be a list or array of skill spans. However, one of ordinary skill in the art will appreciate that other data structures may be employed to represent skill spans without departing from the scope of the innovations described herein.

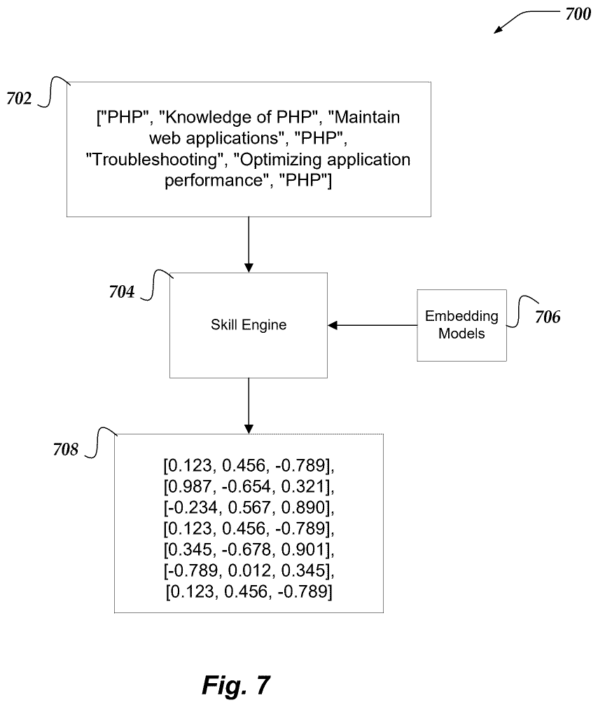

FIG. 7 illustrates a logical schematic of system 700 that may be portion of a skill extraction pipeline in accordance with one or more of the various embodiments. In some embodiments, skill extraction pipelines may be arranged to generate embeddings for skill spans. In some embodiments, skill engines, such as skill engine 702 may be arranged to employ one or more embedding models, such as embedding models 706 to generate embedding vectors, such as embedding vectors 708 for each skill span being considered. In some embodiments, embedding models may be configured to declare one or more particular embedding process for transforming skill spans into vectors of numeric values. In some embodiments, embedding models may declare one or more conventional embedding models/methods such as word2vec, or the like. Also, in some embodiments, embedding models may be configured to employ customized or tuned embedding methods that may be determined by experiment to adapt to encountered raw data. Further, in some embodiments, skill engines may be arranged to execute two or more embedding models in parallel such that results from different embedding models may be compared. For example, in some embodiments, candidate embedding models may be used side-by-side with production embedding models. Accordingly, in this example, skill engines may be arranged to compare embedding results to compare or evaluate the performance of different embedding models.

In some embodiments, skill engines may be arranged to enable embedding models to be configured to generate vectors that represent the skill spans. Accordingly, in some embodiments, values of embedding vectors may enable quantifiable or consistent similarity analysis, or the like, by interpreting the skill spans as existing in a dimensional space where each element of an embedding vector corresponds to dimension that corresponds to a feature characteristic of the skill spans. Accordingly, in some embodiments, conventional vector operations may be employed to analytically evaluate or compare skill spans. In this example, for some embodiments, embedding vectors shown in embedding vectors 708 are illustrated as having 3 elements per vector. However, one of ordinary skill in the art will appreciate that in practice there may be many more elements than shown here. Accordingly, in some embodiments, the particular number of elements in embedding vectors may vary depending on the particular embedding model employed to generate the embeddings.

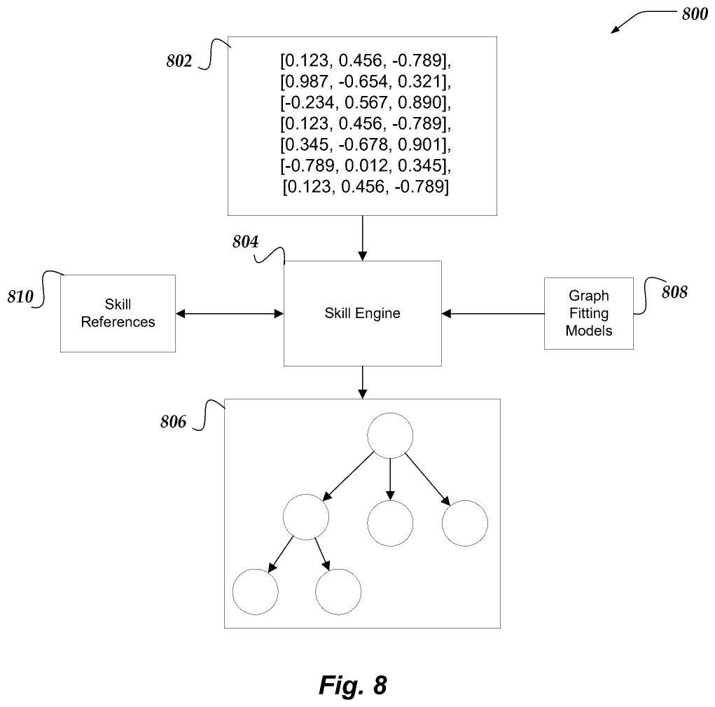

FIG. 8 illustrates a logical schematic of system 800 for a skill node retrieval process that may be included in a skill extraction pipeline in accordance with one or more of the various embodiments. In some embodiments, skill engines, such as skill engine 804 may be arranged to employ one or more graph fitting models, such as graph fitting models 808 to map (or fit) skill span embedding vectors, such as skill embedding vectors 802 into skill graph 806 (or a portion thereof). In some cases, in some embodiments, skill engines may be arranged to generate additional graph nodes (e.g., skill nodes) or relationships for skill spans that may be newly encountered. Also, in some embodiments, skill engines may be arranged to determine if skill spans may be represented in existing skill nodes.

In some embodiments, graph fitting models may be arranged to include rules, instructions, or the like for fitting skill span embedding vectors into a skill graph representation. Accordingly, in some embodiments, element values of skill embedding vectors may be interpreted to represent geometric locations of nodes in the skill graph. Accordingly, in some embodiments, skill engines (with graph fitting models) may be enabled to determine if skill spans are represented in a skill graph. Likewise, in some embodiments, skill engines may be arranged to determine one or more relationships between skill nodes in graph models.

In some embodiments, if skill engines determine that skill spans may be unassociated with existing skill nodes in a skill graph, skill engines may be arranged to employ one or more skill references to search for associated or related skill words that may be associated with skill words included in the skill spans that may be absent from the skill graph. For example, if new skills may be encountered in skill information, corresponding skill spans may be absent from an existing skill graph. Thus, in this example, skill engines may be unable to fit the skill span to the skill graph.

In some embodiments, if skill engines may be unable to fit a skill span to a skill graph, skill engines may be arranged to submit the skill words that correspond to the skill span to one or more skill references. In some embodiments, skill references may be public or private databases of jobs, job descriptions, course descriptions, military occupational specialties, or the like. Accordingly, in some embodiments, descriptions or definitions for the new skill may be discovered. Accordingly, in some embodiments, these skill descriptions may be used to fit the new skills into skill graphs. In some embodiments, skill references may be provided by industry/market affinity associations, government labor and industry agencies, commercial skill/job collections, organization/enterprise job descriptions, public facing web sites, or the like. For example, in some embodiments, if skill engine may be unable to fit a military occupation specialty, such as Army bridge crewmember to its skill graph, the skill engine may be arranged to submit the phrase “bridge crewmember” to a database of military occupations to determine skill information associated with that skill to provide alternative skill spans that may be fit into the skill graph.

In some embodiments, skill engines may be arranged to generate information that may be used to fit new skill nodes into skill graph. In some embodiments, skill engines may be arranged to include this information in one or more prompts that may be used to train generative AI models to predict how to update skill graphs to include the new skill nodes or new relationship edges into the skill graphs. In some embodiments, the generated information may include skill labels, skill node attributes, relationship attributes, or the like, that may be determined by the graph fitting models. In some embodiments, skill engines may be arranged to employ graph fitting models that included instructions for generating prompts or training generative AI models. In some embodiments, skill engines may be arranged to generate or modify graph fitting models based on responses from the generative artificial intelligence models. For example, in some embodiments, skill engines may be arranged to generate prompts that include one or more partitions of a skill graph such that the prompts ask the generative artificial intelligence to optimize the one or more partitions, where such optimizations may include, identifying redundant relationships/edges, including different relationships, including different skill node attributes, or the like. Accordingly, in some embodiments, skill engines may be arranged to automatically update or modify one or more graph fitting models based on the responses from the generative artificial intelligence. In some cases, for some embodiments, skill engines may be arranged to execute modified graph fitting models along size other graph fitting models such that the performance of the different graph fitting models may be compared or otherwise evaluated.

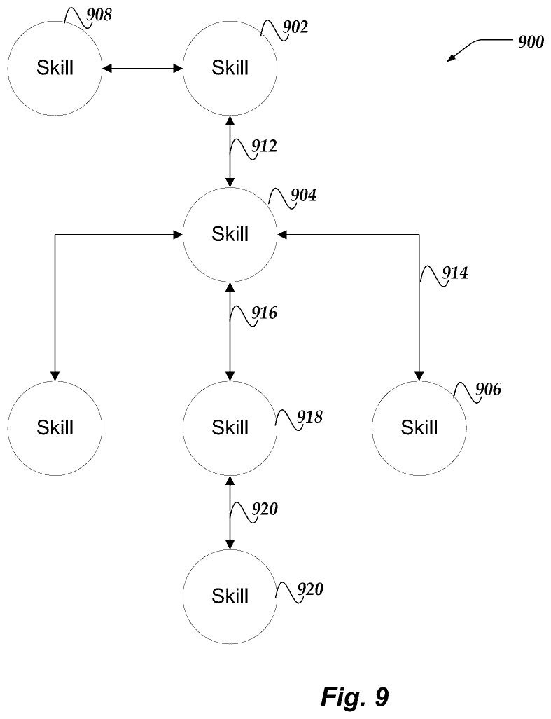

FIG. 9 illustrates a logical schematic of skill graph portion 900 for skill extraction pipelines in accordance with one or more of the various embodiments. As described herein, for some embodiments, skill engines may be arranged to fit skill spans to skill graphs. In some embodiments, nodes in skill graphs may represent skills or skill spans. Also, in some embodiments, one or more relationships between skills or skill spans may be represented by the edges of skill graphs. In some embodiments, each node in a skill graph may represent a skill while edges may be considered to represent one or more relationships associated with related skills.

In some embodiments, skill engines may be arranged to search a skill graph to determine if extracted skills or skill spans may be included in the skill graph. In some embodiments, skill engines may be arranged to employ the skill embedding vectors to match skills or skill spans with nodes in the skill graph. Note, because nodes in skill graphs may represent skills or skill spans, for brevity where skills are mentioned one of ordinary skill in the art may assume that the discussion applies to skill spans as well unless expressly indicated otherwise. Accordingly, in some embodiments, if skill engines may be unable to determine a matching skill, skill engines may generate a new node to the represent the skill that may be absent from the skill graph.

In some embodiments, nodes in skill graphs may include references to the raw data from which the skill was extracted from. Also, in some embodiments, skill nodes may include references to job profiles, learner profiles, course profiles, or the like, that may include the same skill.

In some embodiments, skill engines may be arranged to generate edges that nodes based various metrics associated with various node relationships. Also, in some embodiments, edges may include references to one or more activities or attributes (e.g., trainings, courses, certifications, work history characteristics, or the like) that may be associated with the particular relationships. For example, if a skill node represents the skill Programming, learning or knowing the programming language Java may provide a link or path to another skill node that represents Java Programming. In this example, one edge connecting the Programming skill node to the Java Programming may include taking a Java programming course, verifiable work experience using java, or the like. Accordingly, in some embodiments, skill engines may be arranged to enable skills or skill relationships to be analyzed by the analyzing the skill graph.

In this example, for some embodiments, node 902, node 904, node 908, or node 920 may represent skill nodes. Also, in this example, for some embodiments, edge 912, edge 914, edge 916, edge 920 may represent various collections of attributes or metrics associated with one or more relationships between their respective nodes. Note, for clarity and brevity some nodes or edges are unreferenced. Also, in this example, while edges, such as edge 914 are illustrated using single line, one of ordinary skill in the art will appreciate that there may be many edges between the same nodes or individual edges may represent more than one relationship that associates the nodes. Also, in some embodiments, each relationship may be associated with weights, confidence values, counts, or other metrics that may be consistent with the relationships represented by the edges.

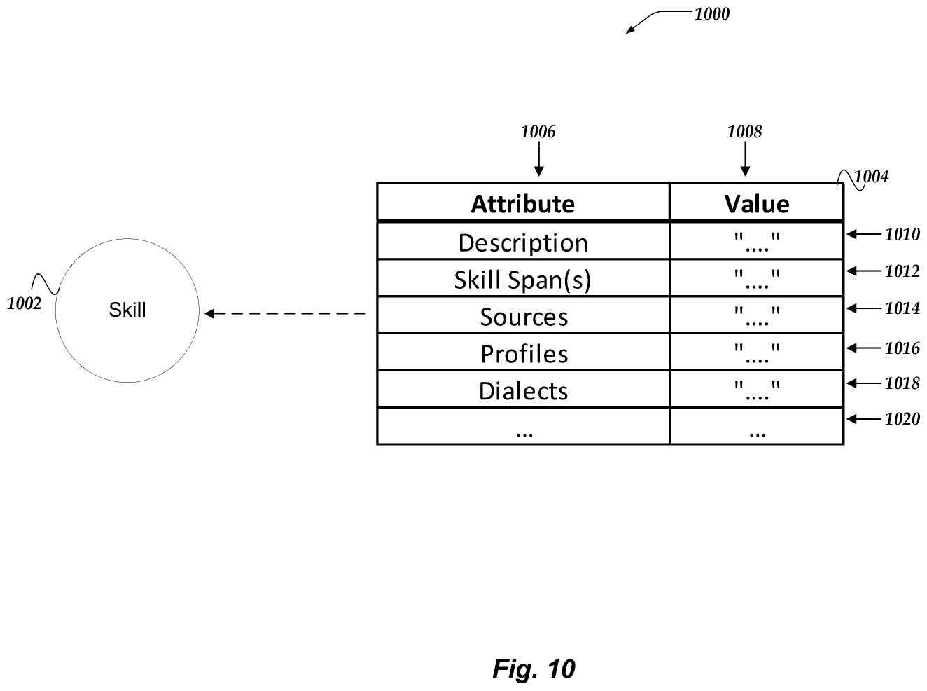

FIG. 10 illustrates a logical schematic of a portion of skill graph 1000 for skill extraction pipelines in accordance with one or more of the various embodiments. As described herein, skill engines may be arranged to employ one or more graph fitting models to fit skills into skill graphs. Accordingly, in some embodiments, nodes in skill graphs may be associated with skills while edges in skill graphs may represent various relationships between skill nodes.

Also, in some embodiments, skill engines may be arranged to associate various attributes with skill nodes. In some embodiments, such attributes may represent various characteristics or features associated with a skill. In some embodiments, these may include skill spans, descriptions, source information, or the like. In some cases, attributes may include metrics, such as commonality, occurrences, number of times skill may be encountered in various sources, desirability, salary information, or the like.

In some embodiments, skill engines may be arranged to be adaptable to the inclusion of additional or different attributes for skill nodes. Accordingly, in some embodiments, as different attributes may be determined of interest, skill engines may be arranged to expand attribute lists as needed. Thus, in some embodiments, skill engines may be arranged to employ libraries, plug-ins, instructions, of the like, provided via configuration information to determine which attributes to associate with skill nodes. Note, in some embodiments, graph fitting models may include rules, instructions, or the like, for associating skill attributes with skill nodes.

In this example, for some embodiments, skill node 1002 may be associated with attribute set 1004. In some embodiments, attribute sets may be data structures used for associating attributes with skill nodes. In this example, for brevity and clarity attribute set 1004 is represented as a table or table-like data structure. However, one of ordinary skill in the art will appreciate that other data structures, such as, arrays, linked lists, dictionaries, hash tables, database tables, objects, structures, or the like, may be used to represent attribute sets without departing from the scope of the innovations disclosed herein.

Accordingly, in this example, for some embodiments, attribute set 1004 represents a portion of the attributes that may be associated with skill node 1002. In some embodiments, column 1006 may represent the name or label of attributes while column 1008 may represent the values (if any) associated with the attributes. For example, in some embodiments, row 1010 may represent or reference a formal description of skill 1002, row 1012 may represent or reference one or more skill spans determined to be associated with skill 1002, row 1014 may represent or reference various sources that were determined to include the skill, row 1016 may represent or reference various profiles in the system that may include the skill, row 1018 may represent or reference one or more dialects of skill 1002, row 1020 represents that there may other or different attributes that may be associated with skill 1002.

In some embodiments, row 1010 may be considered a formal description of the skill. Note, different skills may have the same descriptions. Though such skills with different labels may be strongly related such that they may use different labels to represent the same type of requirements/activities.

In some embodiments, row 1012 may represent that skill spans that may be associated with the skill. In some embodiments, more than one skill span may be determined to represent the same skill. Likewise, in some embodiments, more than one skill may be associated with the same skill spans depending on how graph fitting models may be configured.

In some embodiments, associating sources (e.g., row 1014) with skills may enable skill engines or users to review the original sources that led to the skill being discovered or included in the skill graph. In some cases, there may be multiple sources. In some embodiments, sources may be job postings, resumes, government labor resources, syllabuses, course/training descriptions, job/career descriptions. Accordingly, in some embodiments, the provenance of a particular skill may be reviewed to monitor the quality of skill determination. Note, in some embodiments, skills may be associated with more than source. Accordingly, in some embodiments, skill engines may be arranged to categorize or group different sources. Also, in some embodiments, skill engines may be arranged to enable sources to be associated with quality scores or confidence score. Thus, if a candidate skill may be associated with a single low quality source, the skill may be rejected from inclusion in skill graphs or suspended until more reliable sources verify the skill.

In some embodiments, row 1016 may represent or reference various system profiles that may include the skill. In some embodiments, predictive learner platforms may generate or maintain job profiles, employer profiles, learner profiles, job seeker profiles, educational organization profiles, course profiles, certificate profiles, or the like, that have been derived from various inputs, such as resumes, transcriptions, work history, job postings, course catalogs, syllabuses, or the like that may be ingested.

In some embodiments, row 1018 may represent one or more dialects associated with a particular skill. In some embodiments, different skill labels for the same or similar skills may be encountered. In some cases, different skill labels may be associated with particular skill dialects. For example, in some embodiments, some industries or career areas may use different skill labels for what may be essentially the same skill. In this example, the different industries or career areas may be associated with different skill dialects. Accordingly, in some embodiments, skill engines may be arranged to associate one or more skill dialects with skill nodes. In some embodiments, skill dialects may include categories or groupings such as, military, automobile industry, transportation, marine services, healthcare, childcare, primary education, construction, organizations, or the like. Accordingly, in some embodiments, skill engines may be arranged to enable skills to be accessed or reported using skill labels that may be familiar to particular organizations. Also, in some embodiments, tracking skill dialects may facilitate the identification of skills that may match but for their skill labels.

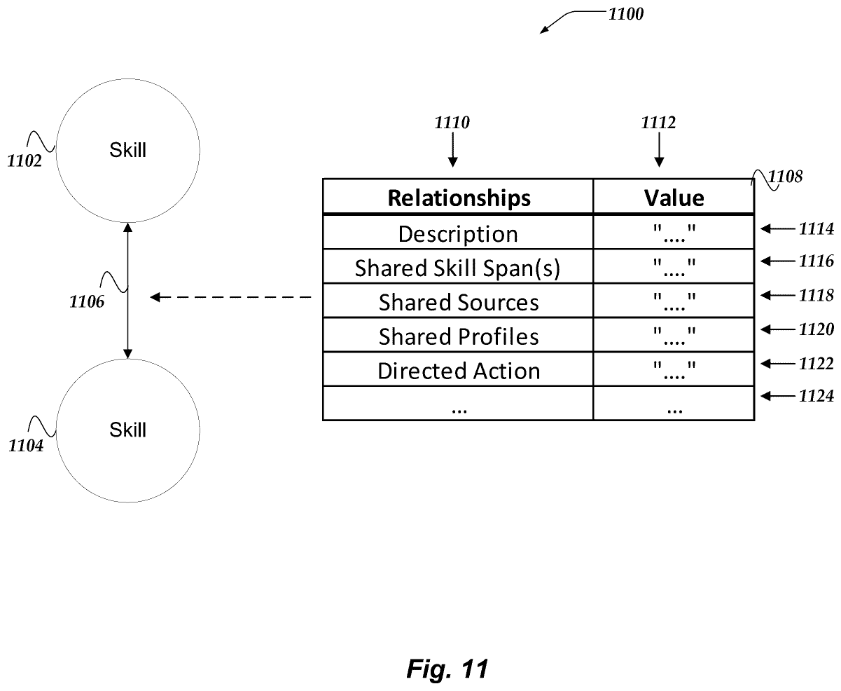

FIG. 11 illustrates a logical schematic of a portion of skill graph 1100 for skill extraction pipelines in accordance with one or more of the various embodiments. As described above, in some embodiments, skill engines may be arranged to employ one or more graph fitting models to determine one or more relationships between skills in the skill graph. In some embodiments, each relationship between or among skills may be considered to be represented by an edge. In some cases, in some embodiments, there may be multiple relationships between skills. Accordingly, in some embodiments, a single illustrated edge may actually represent several relationships between two skills. In some embodiments, logically each relationship between skill nodes may be considered to be a separate edge in the skill graph.

Accordingly, in this example, for some embodiments, skill node 1102 and skill node 1104 may be related by edge 1106 where edge 1106 may represent a bundle of relationships represented in table 1108.

In some embodiments, skill engines may be arranged to be adaptable to the inclusion of additional or different relationships between skill nodes. Accordingly, in some embodiments, as different relationships may be determined of interest, skill engines may be arranged to expand the number of relationships that may be associated with skill nodes as needed. Thus, in some embodiments, skill engines may be arranged to employ libraries, plug-ins, instructions, of the like, provided via configuration information to determine which relationships to associated with skill nodes. Note, in some embodiments, graph fitting models may include rules, instructions, or the like, for associating skill relationships with skill nodes.

In this example, for some embodiments, table 1108 may represent various relationships that may be determined for skill 1102 and skill 1104. In some embodiments, column 1110 may represent a label for a relationship and column 1112 may represent values that may be associated with a particular relationship if required.

In some embodiments, skill engines may be arranged to determine various relationships, such as: row 1114 may represent that the related skills have the same definition; row 1116 may represent one or more shared skill spans that relate skill; row 1118 may represent one or more sources shared by different skills; row 1122 may represent one or more profiles that include the related skills; row 1122 may represent one or more directed actions that may establish a relationship between skill; row 1124 may represent additional relationships between skills.

In some embodiments, directed actions (e.g., row 1122) may represent actions, activities, trainings, course work, verified work experience, test scores, or the like, that may be associated with a transition from one skill to another. For example, if skill 1102 represents the skill Programming and skill 1104 represents the skill Java Programming, a directed action relationship may include verified training in Java Programming, or the like. Accordingly, in some embodiments, skill engines may be arranged to enable skill graph queries (or analysis) that may show various paths of action that may related skills. Referring back to the previous example, other directed action relationships may include, work experience, certifications, or the like. For example, the skill Programming and the skill Java Programming may be related by more than one directed action. Thus, in some embodiments, skill engines may be arranged to generate pathways of actions that may support learning skills where each transition to intermediate skills may be represented as a directed action relationship.

In some embodiments, skill engines may be arranged to employ graph fitting models to determine if an action may enable a person with one skill (e.g., skill holder) to gain another skill. In some embodiments, specialized graph fitting models may be tuned or configured to infer direct actions that may enable skill holders to gain another skill. In some cases, a direct action may simply assign (or verify) that a skill holder has a skill. For example, if a student's transcript shows that they completed a programming course, their student skill profile may include the skill Programming.

Accordingly, in some embodiments, skill engines may be arranged to analyze one or more of course offerings, course prerequisites, or the like, to determine that taking one or more courses that build on skill Programming may lead to other particular skills. In this example, for some embodiments, taking one or more particular courses may be considered a directed actions the leads from the skill Programming to the more advanced or specialized skills. In some embodiments, directed actions may be represented in skill graphs as directed edges.

Note, in some embodiments, relationships are not limited to actions, other relationships, such as, teaching organization (e.g., skills that may be taught by a particular organization), skills associated with a particular career, or the like.

In some embodiments, skill engines may be arranged to employ one or more graph fitting models to determine if particular relationships may be determined between skill nodes. In some cases, one or more relationships may be predicted or probabilistic such that a confidence score may be associated with particular relationships. Also, in some embodiments, graph fitting models, or the like, may be configured to generate a confidence score associated with a directed action than may represent the likelihood of obtaining the related skill after completing the particular directed action. Also, in some embodiments, some directed actions may be additive such that combining actions may increase the likelihood of transitions/traversing from one skill to another related skill.

For example, in some embodiments, if a student may have a career goal of being a Java Programmer, skill engines may be arranged to employ skill graphs to determine a path of actions that may lead enable the student to acquire the skill Java Programming. For example, taking an Introduction to Java Programming course may infer that the student has a 10% chance of gaining a Java Programming skill. But, in this example, if the student did additional Java programming courses, obtained work experience using Java, obtained a Java certificate from a training program, and so on, the student may increase their chance at obtaining the desired Java Programming skill. Thus, in some embodiments, predictive learner platforms may generate a path of actions that the student may follow to verifiably gain the Java Programming skill.

### Generalized Operations

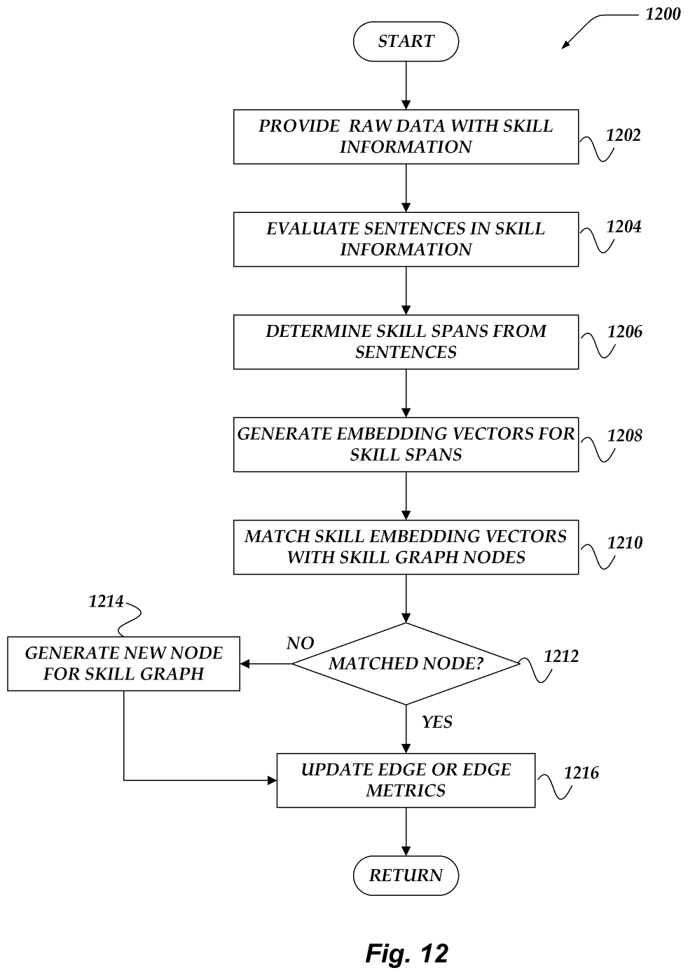

FIGS. 12-17 represent generalized operations for skill extraction pipelines in accordance with one or more of the various embodiments. In one or more of the various embodiments, processes 1200, 1300, 1400, 1500, 1600, and 1700 described in conjunction with FIGS. 1-11 may be implemented by or executed by one or more processors on a single network computer, such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers or containerized instances, such as, those in a cloud-based environment. However, embodiments are not so limited and various combinations of network computers, client computers, or the like may be utilized. Further, in one or more of the various embodiments, the processes described in conjunction with FIGS. 12-17 may perform actions for skill extraction pipelines in accordance with at least one of the various embodiments or architectures such as those described in conjunction with FIGS. 1-11. Further, in one or more of the various embodiments, some or all of the actions performed by processes 1200, 1300, 1400, 1500, 1600, and 1700 may be executed in part by ingestion engine 322, skill engine 324, telemetry engine 326, or the like.

FIG. 12 illustrates an overview flowchart of process 1200 for skill extraction pipelines in accordance with one or more of the various embodiments. After a start block, at block 1202, in one or more of the various embodiments, raw data that includes skill information may be provided. As described above, in some embodiments, raw data may be collected or processed by an ingestion engine. In some embodiments, ingestion engines may be configured to perform various actions to prepare a document or information source for processing by skill engines. In some cases, pre-processing may include optical character recognition (OCR), reformatting, document type classification, or the like. In some embodiments, ingestion engines may be arranged to perform initial analysis of raw data to determine if it may include skill information. Accordingly, in some embodiments, ingestion engines may be arranged to employ one or more machine-learning models to classify raw data or predict if it may include skill information. However, in some embodiments, some or all pre-processing or raw data classification may be performed by skill engines. In some embodiments, in view of completed initial pre-processing, raw data provided to skill engines may be considered to be natural language text.

At block 1204, in one or more of the various embodiments, skill engines may be arranged to evaluate sentences that may be included in the skill information. In some embodiments, skill engines may be arranged to employ natural language processing (NLP) to determine the sentences that may be included in the raw data. In some embodiments, sentences may be natural breaking points in the raw data. Accordingly, in some embodiments, each sentence may be rapidly analyzed using NLP to predict if the contents of the sentence may be associated with skills. In some embodiments, skill engines may be arranged to execute a rapid search for words that may be associated with skills or the performance of activities that may infer skills. In some embodiments, skill engines may be arranged to generate confidence scores or probability scores for predicting if sentences may include skill information.

In some embodiments, skill engines may be arranged to discard sentences that may be associated with a low probability of including skill information. Accordingly, in some embodiments, skill engines may be arranged to discard one or more sentences that may be associated with confidence scores that may be less than a threshold value. Note, in some embodiments, skill engines may be arranged to determine confidence score threshold values from configuration information to account local requirements or local circumstances.

At block 1206, in one or more of the various embodiments, skill engines may be arranged to determine one or more skill spans from the evaluated sentences. In some embodiments, skill engines may be arranged to employ one or more skill extraction models to identify short and related sequences of one or more words in the evaluated sentences that may be associated with skills or skill activities. In some embodiments, skill spans capture words that may be near skill words to provide additional context. Accordingly, in some embodiments, skill spans capture context that may enable additional or particular skills to be identified. In contrast, relying on single skill words to identify skills may miss important context that may distinguish related but different skills from each other.

Further, in some embodiments, skill spans may be associated with broader or different skill concepts than otherwise could be inferred. Accordingly, in some embodiments, determining skill spans from sentences associated with skill information may enable inference of additional skills that may otherwise be hidden from a surface analysis. For example (referring FIG. 6), a naive skill extraction system may recognize the word PHP in the sentences (in data 602) and relying on it to infer the skill of interest is PHP. But as seen in, skill engines may be arranged to identify skill spans that include skill spans that include obvious skill words such as PHP as well as skill spans such as “maintain web applications”, “knowledge of PHP”, “optimizing application performance”, or the like. Thus, in this example, for some embodiments skill engines may be enabled to recognize that the skill information may include more skills that may be matched or determined in subsequent actions.

At block 1208, in one or more of the various embodiments, skill engines may be arranged to generate embedding vectors for the one or more skill spans.

In some embodiments, skill engines may be arranged to employ one or more embedding models to generate skill embedding vectors from skill spans. In some embodiments, skill spans provide a richer or broader information space that may enable more skills to be distinguished or matched. In contrast, limiting embeddings to single skill words (e.g., PHP, or the like) may result in a more restricted information space which to match or identify skills. For example, a skill span could include “maintaining web applications” which may infer particular skills that go beyond just familiarity or expertise with the PHP programming language.

In some cases, skill engines may employ conventional or standard embedding models as well as customized embedding models.

At block 1210, in one or more of the various embodiments, skill engines may be arranged to match the skill embedding vectors with nodes in a skill knowledge graph (skill graph). In some embodiments, skill engines may be arranged to employ one or more graph fitting models to match skill embeddings with skill nodes in skill graphs. In some embodiments, graph fitting models may include heuristics, rules, or the like, for comparing skill embedding vectors with embedding vectors associated with skill nodes in the skill graph. In general, for some embodiments, skill engines may be arranged to evaluate the geometric distance between points represented by the embeddings in the skill information space that may be within a distance threshold value. In some embodiments, the distance from a point in the skill space represented by a skill embedding vector may be mapped or translated into a confidence score such that matches associated with smaller distances from the skill node point may be associated with increased confidence scores than skill embedding vectors that may be further away from skill node embedding vectors.

In some embodiments, skill engines may be arranged to be adaptable to employing different graph fitting models or different embedding models concurrently to enable results from different models to be compared or evaluated against each other. In some embodiments, skill engines may be arranged to associate performance scores with different graph fitting models or different embedding models. Accordingly, in some embodiments, skill engines may be arranged to automatically compare graph fitting results or embedding results associated with different models. For example, in some embodiments, matched or identified skills determined based on different graph fitting models may be compared by submitting the skills to generative AI systems to evaluate which graph fitting model may produce a better representation of for skill extraction pipelines. Similarly, in some embodiments, skill engines may be arranged to evaluate the performance of different embedding models against each other.

At decision block 1212, in one or more of the various embodiments, if the skill node may be matched, control may flow block 1216; otherwise, control may flow to block 1214.

At block 1214, in one or more of the various embodiments, skill engines may be arranged to generate a new node in the skill graph for a new skill. In some embodiments, skill engines may be configured to initially assume that unmatched skill embedding vectors may be associated with different skills. Accordingly, in some embodiments, skill engines may be arranged to generate new skill nodes for unmatched embedding vectors. In some embodiments, skill engines may be arranged to generate specialized generative AI prompts that may include the skill span associated with the unmatched embedding vector to predict or recommend a skill label to associated with the new skill node. Accordingly, in some embodiments, skill engines may be arranged to employ generative AI with one or more specialized prompts to determine skill labels, or the like, for new skill nodes.

Also, in some embodiments, skill engines may be arranged to perform additional analysis confirm if the predicted new skill should be included in the skill graph. Accordingly, in some embodiments, skill engines may be arranged to employ one or more external references or information sources to attempt to confirm that the predict new skill label fits the skill span. In some embodiments, skill engines may be arranged to execute search engine queries that include the new skill label to observe if the results may be consistent with skill span. Also, in some embodiments, skill engines may be arranged to generate one or more generative AI prompts that include the raw data skill information as context to may be used to evaluate if the new skill label may be consistent with the skill information.

At block 1216, in one or more of the various embodiments, skill engines may be arranged to update edges or edge metrics in the skill graph. In some embodiments, edges (e.g., relationships or relationship metrics) may be updated for matched skill nodes while new edges may be generated for new skill nodes.

Likewise, in some embodiments, skill engines may be arranged to update or generate skill node attributes, such as references to source raw data, reference to related skill spans, or the like.

In some embodiments, skill engines may be arranged to employ one or more graph fitting models to generate edges to new skill nodes.

In some embodiments, if new or updated graph fitting models may be available, skill engines may be arranged to update edges or skill node attributes based on the updated graph fitting models.

Next, in one or more of the various embodiments, control may be returned to a calling process.

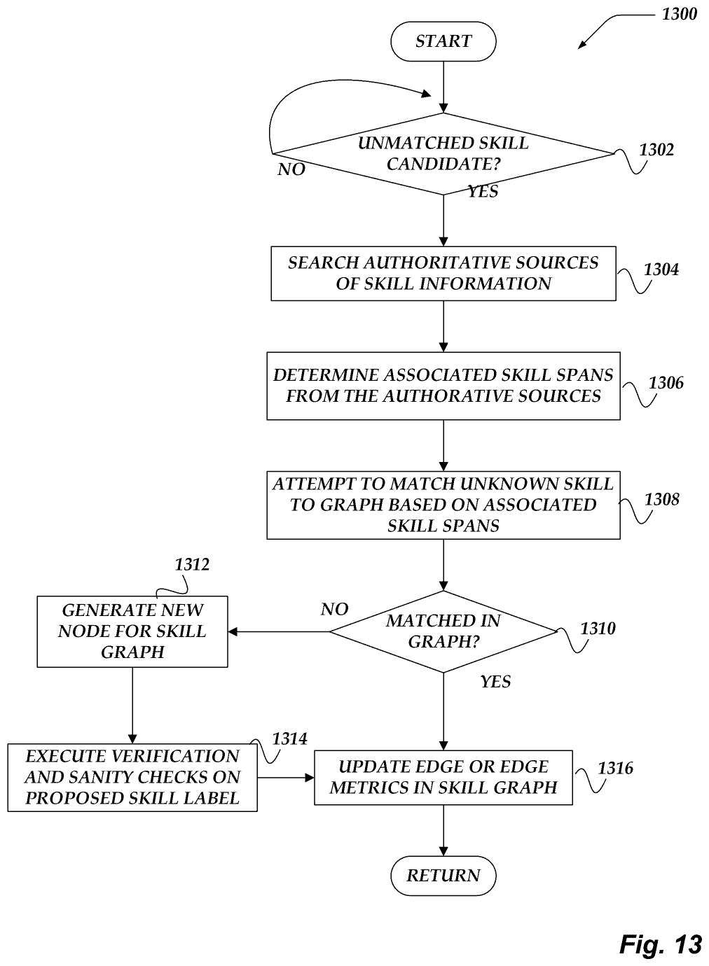

FIG. 13 illustrates a flowchart of process 1300 for skill extraction pipelines in accordance with one or more of the various embodiments. After a start block, at decision block 1302, in one or more of the various embodiments, if skill engines encounter an unmatched skill candidate, control may flow to block 1304; otherwise, control may loop back to decision block 1302. In some embodiments, unmatched skills may be skills that skill engines may be unable to match with existing skill nodes in the skill graph. Accordingly, in some embodiments, skill engines may be arranged to perform additional actions to evaluate the candidate skill to determine if a new skill node may be added to the skill graph.

As described above, in some embodiments, skill engines may be arranged to attempt to match candidate skills with skill nodes by matching skill spans associated with the candidate skills to skill spans associated with existing skill nodes. In some embodiments, skill embedding vectors associated with matched skills may correspond to skill embedding vectors of known skills in the skill graph. Accordingly, in some embodiments, skills associated with skill embedding vectors that have a geometric distance from skill embedding vectors of existing skill nodes that exceeds a defined threshold value may be determined to be unmatched.

In some embodiments, skill engines may be arranged to perform additional actions to determine if the candidate skills should be discarded or added to the skill graph. Accordingly, in some embodiments, skill engines may be arranged to automatically evolve or adapt skill graphs as new skills may be encountered rather than being restricted to providing a static dictionary of skills.

At block 1304, in one or more of the various embodiments, skill engines may be arranged to search one or more authoritative sources for information associated with candidate skills. In some embodiments, skill engines may be arranged to submit queries to one or more internal or external sources to obtain information that may be employed to determine if the candidate skill should be added to the skill graph. In some embodiments, such sources may include general purpose search engines, specialized career information databases, industrial/commercial journal/media collections, government resources, local skill information data stores, or the like.

In some embodiments, responses to such queries may be collected to predict if the candidate skill may be confirmed as a skill that should be added to a skill graph.

In some embodiments, skill engines may be arranged to process query responses similarly as raw data that includes skill information. In some embodiments, skill engines may be arranged to employ customized prompts that may be submitted to generative AI to compare the original raw data skill information associated with candidate skills to the responses from the queries skill information sources. Accordingly, in some embodiments, response from the generative AI may be employed to confirm if the query results may be correlated or otherwise matched with the original raw data. For example, if the generative AI determines the meaning or concepts associated with query results diverge from the meaning or concepts associated with the original raw data, the candidate skill may be discredited. In contrast, if the query results may be determined to be consistent with the original raw data skill information, skill engines may be arranged to infer that the candidate skill may be eligible for including in the skill graph.

Similarly, in some embodiments, skill engines may be arranged to submit queries that include the one or more skill spans associated with the candidate skill to the one or more authoritative skill information sources. Accordingly, in some embodiments, responses from the authoritative skill information sources may include one or more natural language text responses. In some embodiments, skill engines may be arranged to generate generative AI prompts that compare the one or more responses to the candidate skill labels to determine if the candidate skill label may be consistent with one or more responses.

Further, in some embodiments, skill engines may be arranged to employ additional heuristics for verifying candidate skill labels. In some embodiments, skill engines may be arranged to evaluate if the candidate skill label may be in common use. Accordingly, in some embodiments, skill engines may be arranged to evaluate the number of particular online sources that reference the candidate skill label.

Also, in some embodiments, skill engines may be arranged to execute one or more NLP similarity tests to evaluate if the results of the queries may be similar or related to the original skill information. In some embodiments, skill engines may be arranged to evaluate if the query results include skill information similar to how the raw data may be evaluated. Accordingly, in some embodiments, query results that may not include skill information may be excluded. Note, in some embodiments, skill engines may be configured to aggressively exclude query results to reduce the likelihood of false positives.

At block 1306, in one or more of the various embodiments, skill engines may be arranged to determine one or more associated skill spans based on the authoritative sources. In some embodiments, skill engines may be arranged to determine skill spans from the query results using the some or all of the methods for determining skill spans from the original raw data skill information.

Note, in some embodiments, skill engines may be arranged to exclude one or more query results based on actions performed for block 1304. For example, in some embodiments, one or more query results that were determined to be unrelated to the original skill information may be discarded.

Thus, in some embodiments, skill engines may have generated a collection of alternative skill spans that may be associated with the candidate skill. In some embodiments, because these alternative skill spans may be collected from authoritative skill information sources based on the original skill information or original skill spans that may be predicted to be related to the candidate skills.

At block 1308, in one or more of the various embodiments, skill engines may be arranged to attempt to match the candidate skill with the skill graph based on the associated skill spans.

In some embodiments, skill engines may be arranged to generate skill embedding vectors for the skill spans that may be associated with the candidate skill. In some embodiments, generating the embedding vectors for the candidate skill spans may be performed similarly as described above for skill spans determined from the raw data skill information.

In some embodiments, skill engines may be arranged to compare the candidate skill spans with skill spans associated with skill nodes. In some embodiments, this comparison may be based on embedding vectors, or the like, as described above.

At decision block 1310, in one or more of the various embodiments, if the candidate skill may be matched in the skill graph, control may flow to block 1314; otherwise, control may flow to block 1312.

At block 1312, in one or more of the various embodiments, skill engines may be arranged to generate a new skill node in the skill graph for the candidate skill.

In one or more of the various embodiments, skill engines may be arranged to generate one or more prompts that include context information based on one or more of the accepted query results (from block 1304), the determined skill spans (from block 1306), or the like, such that the one or more prompts may query generative AI to predict a suitable skill label for the candidate skill.

In some embodiments, skill engines may be arranged to generate skill labels that conform to a particular “dialect” where different dialects may be associated with different types of labor markets, educational contexts, training contexts, or the like. In some cases, different types of labor markets, educational contexts, training contexts, or the like, may use different skill labels to represent what may be essentially the same skills. For example, skill labels used by the military may be different than skill labels used in the commercial construction industry, or the like. Accordingly, in some embodiments, skill engines may be arranged to employ specialized prompts for predicting skill labels where one or more specialized prompts may be directed to particular skill dialects. For example, in some embodiments, skill engines may be arranged to generate a prompt for determining military dialect skill labels by including context information that directs the generative AI to seek out skill labels that may be appropriate for military programs.

In some embodiments, skill engines may be arranged to request generative AI seek skill labels of different dialect by using different specialized prompts for each dialect. Also, in some embodiments, skill engines may be arranged to configure prompts that direct generative AIs to seek out skill labels for different dialects in one prompt. For example, in some embodiments, a prompt may include questions for the generative AI, such as: suggest a skill label that is suitable for use in the US Army; suggest another skill label that is suitable for the use in the US Navy; suggest another skill label that is suitable for use in the US commercial construction industry; or the like.

In some embodiments, if a skill label may be determined, the skill engines may be arranged to generate a new skill node for the predicted skill label. Accordingly, in some embodiments, the new skill node may be included in the skill graph.

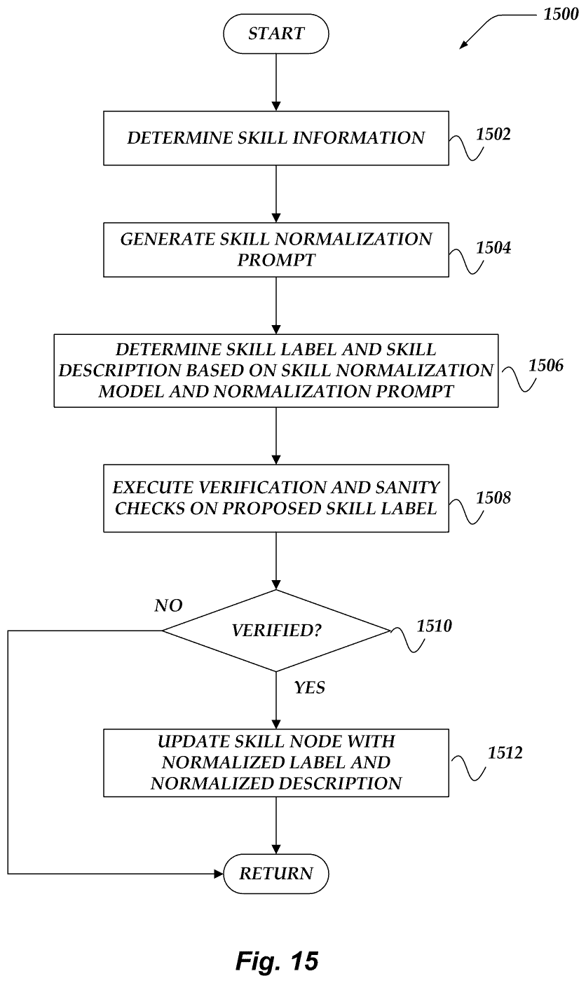

At block 1314, in one or more of the various embodiments, skill engines may be arranged to execute verification and sanity checks on proposed skill labels. In some embodiments, skill engines may be arranged to resubmit one or more of the predicted skill labels to one or more authoritative skill information sources to validate if the skill label may be suitable. For example, in some embodiments, if the generative AI predicts a skill label that if submitted to a general purpose search engine fails to produce skill information consistent with the information used for predicting the skill label, skill engines may infer that the predicted skill label may be unsuitable. In contrast, in some embodiments, if the predicted skill label is consistent with subsequent results from queries to search engines, or the like, skill engines may be configured to consider that the predicted skill label may be suitable for inclusion in the skill graph. (See, the description for FIG. 15, block 1508 for a more detailed description.)

At block 1316, in one or more of the various embodiments, skill engines may be arranged to update the edges or edge metrics in the skill graph. As described above for block 1216, skill engines may be arranged to update the edges, edge metrics, or skill node attributes based on the new skill or the matched skill.

Next, in one or more of the various embodiments, control may be returned to a calling process.

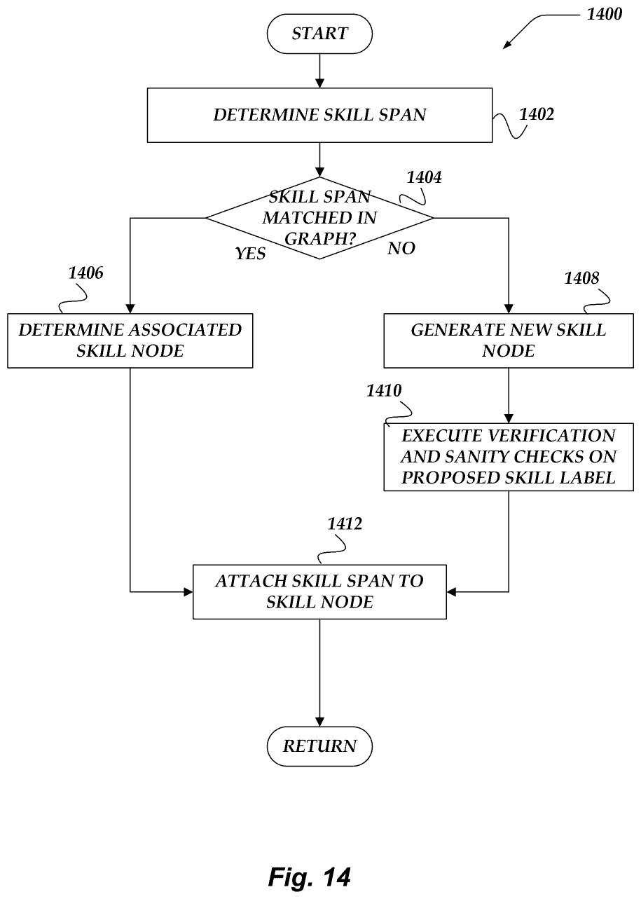

FIG. 14 illustrates a flowchart of process 1400 for skill extraction pipelines in accordance with one or more of the various embodiments. After a start block, at block 1402, in one or more of the various embodiments, skill engines may be arranged to determine one or more skill spans. As described above, in some embodiments, skill engines may be arranged to determine one or more candidate skill spans from raw data that includes skill information.

In some embodiments, skill engines may be arranged to generate a skill embedding vector for each candidate skill span. In some embodiments, skill engines may be configured to employ one or more of a conventional embedding methodology or a custom methodology. In some cases, open source or commercially available embedding libraries or embedding services may be employed to generate embedding vectors from skill spans.

At decision block 1404, in one or more of the various embodiments, if the one or more skill spans are matching in the skill graph, control may flow block 1406; otherwise, control may flow to block 1408. In some embodiments, skill engines may be arranged to employ one or more graph fitting models that may include or declare instructions, conditions, rules, or the like, for comparing candidate skill span embedding vectors with embedding vectors associated with skill nodes in a skill graph. Note, in some embodiments, skill nodes may be associated with more than one skill span (each with different skill span embedding vectors.)

Accordingly, in some embodiments, skill engines may be configured to determine a match based on a point represented by the candidate skill embedding vector being within a maximum geometric distance from a skill embedding vector that is associated with a skill node. In some embodiments, the threshold value for determining if a candidate skill embedding vector matches an existing skill embedding vector may be determined based on conditions or rules declared in graph fitting models. Accordingly, in some embodiments, skill engines may be arranged to be adapted to local requirements or local circumstances by changing which graph fitting model is being used or by modifying existing graph fitting models.

At block 1406, in one or more of the various embodiments, skill engines may be arranged to determine associated skill node. In some embodiments, skill embedding vectors in the skill graph may be based on skill spans that may be associated with skill nodes. Accordingly, in some embodiments, skill engines may be arranged to determine the skill node that may be associated with skill spans that matched the candidate skill spans.

Next, in one or more of the various embodiments, control may flow to block 1410.

At block 1408, in one or more of the various embodiments, skill engines may be arranged to generate a new skill node in the skill graph.

In some embodiments, skill engines may be arranged to perform one or more actions to determine if the unmatched skill span may be associated with a recognized skill. In some embodiments, this may include automatically submitting the skill span to various authoritative sources, such as include general purpose search engines, specialized career information databases, industrial/commercial journal/media collections, government resources, local skill information data stores, or the like. Accordingly, in some embodiments, if responses from these sources provide consistent skill/activity descriptions or definitions, the skill span may be predicted to represent a skill that may be absent from the skill graph.

Further, in some embodiments, skill engines may be arranged to employ generative AI to compare different responses to predict if responses from different sources may be consistent. For example, in some embodiments, skill engines may be arranged to generate a prompt that includes two or more responses from the authoritative sources and a question to the Large Language Model asking if the two or more responses are discussing the same skill.

Also, in some embodiments, skill engines may be arranged to generate a skill label for the new skill node. In some embodiments, skill engines may be arranged to employ specialized prompts that ask generative AI to predict a skill label based on skill information, skill spans, one or more authoritative verification responses, or the like. Next, in some embodiments, if the generative AI predicts a skill label, skill engines may be arranged to execute one or more actions to verify the predicted skill label. In some embodiments, skill engines may be arranged to generate another prompt that asks another generative AI to describe actions, skill, activities, or the like, that may be associated with the new skill label. Also, in some embodiments, skill engines may be arranged to submit the skill label to various authoritative sources, such as general purpose search engines, specialized career information databases, industrial/commercial journal/media collections, government resources, local skill information data stores, or the like, such that the responses evaluated to determine if the new skill label represents a skill that should be included in the skill graph.

At block 1410, in one or more of the various embodiments, skill engines may be arranged to execute verification and sanity checks on proposed skill labels. In some embodiments, skill engines may be arranged to resubmit one or more of the predicted skill labels to one or more authoritative skill information sources to validate if the skill label may be suitable. For example, in some embodiments, if the generative AI predicts a skill label that if submitted to a general purpose search engine fails to produce skill information consistent with the information used for predicting the skill label, skill engines may infer that the predicted skill label may be unsuitable. In contrast, in some embodiments, if the predicted skill label is consistent with subsequent results from queries to search engines, or the like, skill engines may be configured to consider that the predicted skill label may be suitable for inclusion in the skill graph. (See, the description for FIG. 15, block 1508 for a more detailed description.)

At block 1412, in one or more of the various embodiments, skill engines may be arranged to associate the skill span with the skill node. In some embodiments, skill nodes may be associated with more than skill span. Accordingly, in some embodiments, the candidate skill span may be attached or linked to its associated skill node. Also, in some embodiments, along with the skill span, the raw skill information source of the new skill spans may be associated with the skill node as well. Accordingly, in some embodiments, subsequent analysis using the skill graph may include results or reports that may be based on the original skill information.

Next, in one or more of the various embodiments, control may be returned to a calling process.

FIG. 15 illustrates a flowchart of process 1500 for skill label normalization for skill extraction pipelines in accordance with one or more of the various embodiments. In some cases, the “same” skill may have different skill labels in different employment or training contexts. In some embodiments, different industries may use different labels for activities or capabilities that may be similar. Accordingly, in some embodiments, skill engines may be arranged to determine if skills with different labels may be effectively the same skill.

Also, in some embodiments, skill engines may be arranged to populate skill search reports (or other analysis reports) using skill labels that may be normalized for a particular context. For example, in some embodiments, some skills in commercial construction may be the same or similar to some skills in the US Army. However, for the purposes of this example, the skill labels for similar skills may be different. For example, operating a bulldozer may be a skill that is common to the military and civilian commercial construction. But, in this example, the skill label for civilian commercial construction bulldozer operators may be Heavy Equipment Operator while the US Army bulldozer operator may be referred to as Horizontal Construction Engineer. Clearly, in this example, these two skills may be the same or similar but since they are in different industries/employment contexts they have different skill labels. Accordingly, in some embodiments, the different skill labels for the same skill may cause confusion, unexpected mismatches, or the like for analysis for skills. For example, for some embodiments, if an employer is searching for candidates that have the skill of Heavy Equipment Operator, a conventional search may miss or omit candidates that have the skill Horizontal Construction Engineer in their profiles. Likewise, reporting information about population skills, skill gaps, training proposals, education plans, or the like, may be improved using skill labels that may be normalized for particular contexts.

In some embodiments, skill engines may be arranged to employ skill label models that may use generative AI to predict one or more skill labels normalized to a skill dialect based on the included context. In some embodiments, skill label models may be considered data structures that encapsulate the rules, instructions, or the like, that may be used for normalizing skill labels or skill descriptions.

After a start block, at block 1502, in one or more of the various embodiments, skill engines may be arranged to determine skill information. Here, skill information may include the raw data, skill spans, skill embedding vectors, skill attributes, edges, edges attributes, or the like, that may be determined for a skill from a skill graph. In some cases, skill engines may be configured normalized skills that may already be included in the skill graphs. Also, in some embodiments, skill engines may be arranged to normalize skill labels when new skills may be encountered as part of the graph fitting process. Accordingly, in some embodiments, information for normalizing skill labels may be obtained from skill graphs, candidate skill information (e.g., raw data, candidate skill spans, or the like), or the like.

At block 1504, in one or more of the various embodiments, skill engines may be arranged to generate skill normalization prompts.

In some embodiments, skill engines may be arranged to generate one or more generative AI prompts to predict normalized skill labels. In some embodiments, skill engines may be arranged to select one or more prompts or prompt templates that may be provided for skill label normalization.

In some embodiments, skill engines may be arranged to inject skill information for the skill label being normalized into the normalization prompts. In some embodiments, normalization prompts may be configured to include context information or directives that ask the generative AI to predict alternative skill labels that may be suitable for the provided context.

In some embodiments, prompts may be adapted or modified based on observation or experimentation. In some embodiments, one or more experimental prompts may be employed alongside the prompts used in production. Accordingly, in some embodiments, the normalized label predicted by the production prompts may be compared with the normalized labels predicted by the experimental prompts. Thus, in some embodiments, if the experimental prompts become advantageous, skill engines may be configured automatically employ the former experimental prompts. Accordingly, in some embodiments, metrics such as user satisfaction, generative AI costs, performance metrics (e.g., latency, context size limitations, or the like), results of sample testing/training, or the like, may be applied to determine if a prompt may be used in production. Note, in some cases, different generative Als or generative AI services may be experimentally used in parallel to enable the results from different generative AIs or generative AI services to be compared or otherwise evaluated.

Also, in some embodiments, similar to determining prompts for normalized skill labels, skill engines may be arranged to employ one or more prompts for determining normalized skill descriptions where the normalized skill descriptions may be tailored for particular contexts. Thus, in some embodiments, the normalized skill labels and the normalized skill descriptions may be familiar to users in given context. For example, a skill report generated for a US Army user may report skill labels and skill descriptions using terms that may be familiar to the user. Likewise, for example, a similar skill report generated for a North American commercial construction workers may use terms that would be familiar to North American commercial construction workers.

In some embodiments, skill engines may be arranged to employ normalization models that may be data structures that encapsulate heuristics, rules, instructions, or the like, for determining normalized skill labels. Accordingly, in some embodiments, as different normalization processes may be determined or selected, different normalization models may be used or existing normalization models may be modified.

At block 1506, in one or more of the various embodiments, skill engines may be arranged to determine the skill label and skill description based on the normalization models and the normalization prompts.

At block 1508, in one or more of the various embodiments, skill engines may be arranged to execute one or more verification or sanity checks on the proposed skill label.

In some cases, in some embodiments, results produced by generative AIs may be incorrect even though the generative AI asserts the veracity of its predicted skill labels. In some cases, this erroneous behavior may be referred to as hallucinations. Accordingly, in some embodiments, skill engines may be arranged to perform one or more actions to verify or validate skill labels predicted by normalization models.

In some embodiments, skill engines may be arranged to execute various verification actions. In some cases, one or more verification actions may generate a partial verification score such that a sum of scores for one or more verification actions may be employed to grade predicted skill labels. Also, in some embodiments, one or more verification actions may trigger rejection of predicted skill labels. Accordingly, in some embodiments, skill engines may be arranged to execute one or more actions to attempt to verify predicted skill labels.

In some embodiments, skill engines may be arranged to submit the predicted skill label to one or more authoritative skill data sources, such as, general purpose search engines, specialized career information databases, industrial/commercial journal/media collections, government resources, local skill information data stores, or the like. Accordingly, in some embodiments, skill engines may be arranged to automatically compare one or more of the verification results with the skill information associated with the predicted skill labels.

For example, in some embodiments, skill engines may be arranged to generate a generative AI prompt that directly asks a Large Language Model if the predicted normalized skill label and the related skill labels are associated with the same skill. Generally, in some embodiments, if a response from a large language model indicates that a predicted normalized skill label and an original skill label represent the similar skills or the same skills, skill engines may be arranged to consider the predicted skill label as verified.

Also, for example, in some embodiments, skill engines may be arranged to query an authoritative source for a description of skills associated with skill labels. Accordingly, in some embodiments, skill engines may be arranged to generate a generative AI prompt that asks large language models if the determined descriptions match the predicted normalized skill label.

Also, in some embodiments, skill engines may be arranged to submit queries to job/career/training sources that are in the same employment context (same dialect) as the predicted normalized skill label. Accordingly, in some embodiments, skill engines may be arranged to evaluate if the responses match the predicted normalized skill label.

In some embodiments, skill engines may be arranged to employ rules, instructions, conditions, or the like, for verifying predicted skill labels provided by configuration information to account for local requirements or local circumstances. In some cases, for some embodiments normalization models may include instructions, rules, or the like, for performing some or all verification actions.

At decision block 1510, in one or more of the various embodiments, if the new skill label may be verified, control may flow to block 1512; otherwise, control may be returned to a calling process.

At block 1512, in one or more of the various embodiments, skill engines may be arranged to update the skill node with a normalized title and a normalized description. In some embodiments, skill nodes for normalized skill labels may be different skill nodes that may be connected by one or more edges to the other skill nodes in the skill graph that match the meaning of the normalized skill label.

Also, in some embodiments, skill engines may be arranged to update one or more attributes of a base skill node to include the normalized skill label and normalized skill definition. Thus, in some embodiments, viewing a skill node may enable access to each of its alternative (e.g., normalized) skill labels for different contexts/dialects.

Next, in one or more of the various embodiments, control may be returned to a calling process.

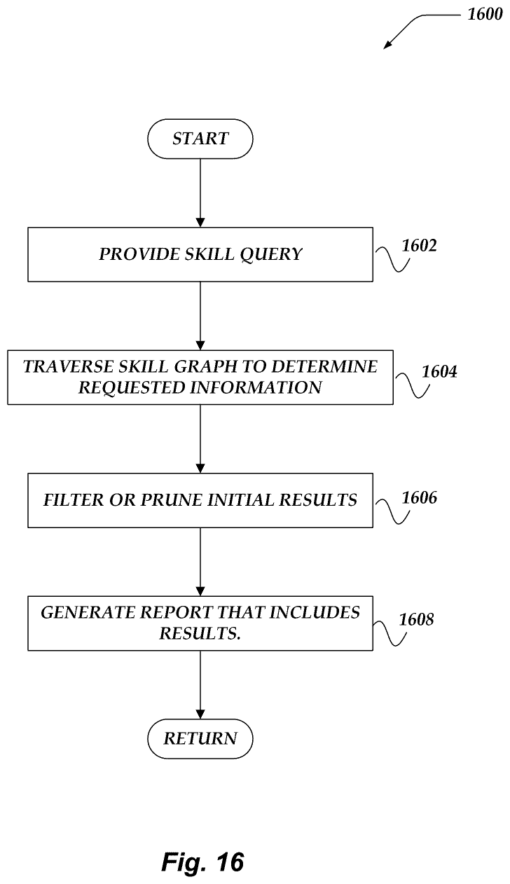

FIG. 16 illustrates a flowchart of process 1600 for skill extraction pipelines in accordance with one or more of the various embodiments. After a start block, at block 1602, in one or more of the various embodiments, skill engines may be enabled to receive one or more skill queries. In some embodiments, skill engines may be arranged to enable one or more analysis applications to access skill graphs. In some embodiments, skill engines may be arranged to provide one or more APIs that enable other applications or services to access skill graphs. In some embodiments, the one or more APIs may enable analysis applications to indirectly or directly provide skill query information. In this case, indirectly provided query information may be provided via APIs that may be dedicated to a specific reports or analysis operations. Also, directly provided query information may be provided via APIs that accept one or more query language expressions as inputs. For example, APIs that accept query expressions in graphQL or graphQL-like formats may be considered an API that directly accepts query information.

In one or more of the various embodiments, skill engines may be arranged to support one or more query languages. In some embodiments, skill engines may be arranged to support one or more plug-ins, extensions, or the like, that enable support for additional query languages or query language features. Also, in some embodiments, skill engines may be arranged to enable users to supply one or more stored procedures, or the like, that may be employed.

In some embodiments, analysis applications may employ one or more direct APIs to submit one or more query language expressions to graph engines. Also, in some embodiments, analysis applications may employ one or more indirect APIs that result in the skill engines generating query information to determine the results for the specific ‘question’ associated with the indirect APIs. For example, in some embodiments, skill queries may be directed to identify job seekers, students, current employees, or the like, that may have particular skills. Accordingly, in some embodiments, skill nodes in skill graphs may include references to profile data structures associated with one or more of job seekers, students, current employees, or the like, that may be relevant to the query.

Similarly, in some embodiments, skill queries may be directed to identify training courses, occupational specialties, education programs, or the like, that may be associated with particular skills. Accordingly, in some embodiments, skill nodes that may be identified by the queries may include references to course profiles, syllabus profiles, training program profiles, educational program profiles, or the like.

In some cases, in some embodiments, graph fitting models may establish relationships between skill nodes based on actions or verifiable facts that may lead from one skill to another. For example, skill node Programming may be linked to skill node Java Programming by one or more actions, such as, taking a course or training program that teaches Java programming, verified work history as working as a Java programmer, or the like. Accordingly, in some embodiments, skill queries may be directed to determine actionable pathways for gaining skills. For example, a user with a verifiable Programming skill may receive a report of courses, trainings, or the like, that would result in the user gaining the skill Java Programming. Note, in some cases, there may be multiple paths with various intervening skill nodes between the user's start point and their ultimate goal. Similarly, in some embodiments, employers may employ such queries to determine training programs pathways to enable employees to obtain one or more desired skills.

In some embodiments, skill engines may be arranged to evaluate the query information for correctness using one or more parsers, grammar-checkers, or the like. Also, in some embodiments, skill engines may be arranged to confirm that the analysis applications associated with the query information may have the rights or privileges to access the skill graphs that may be associated with the query information. In one or more of the various embodiments, skill engines may be arranged to employ one or more grammars, parsers, or the like, provided via configuration information. Thus, in some embodiments, skill engines may be arranged to support more than one query language.

In one or more of the various embodiments, if a skill engine may be unable to confirm that the provided query information is correct or otherwise valid, the query information may be rejected and an error response may be returned to the associated analysis applications.

At block 1604, in one or more of the various embodiments, skill engines may be arranged to employ the skill graph to determine results for the provided queries. In some embodiments, skill graphs may be implemented in so-called native graph-based databases that include native support graph oriented query languages. Also, in some embodiments, skill engines may be arranged to support multiple query languages that enable relevant queries to be expressed.

At block 1606, in one or more of the various embodiments, skill engines may be arranged to filter or prune the initial query results.

In some embodiments, skill engines may be arranged to process query results to conform to one or more requirements of its interface/API. In some embodiments, skill engines may be arranged to return results as graphs (e.g., skill nodes and edges). Also, in some embodiments, skill engines may be arranged to transform the results into conventional records, objects, lists, or the like. In some embodiments, the particular format for the results may be determined based on configuration information or query information. In some embodiments, skill engines may be arranged to employ rules, parsers, libraries, or the like, provided by configuration information for formatting results to account for local circumstances or local requirements.

In some embodiments, skill engines may be arranged to mask some or all personally identifiable information (PII) that may be included in the query results. Accordingly, in some embodiments, some queries related to generalized reports may hide PII to protect the privacy of students, employees, job candidates, or the like, or otherwise conform to local privacy requirements.

At block 1608, in one or more of the various embodiments, skill engines may be arranged to generate one or more reports that include the final query results.

In some embodiments, skill engines may be arranged to generate various reports including interactive reports. In some embodiments, skill engines may be arranged to integrate with report engines, graphical visualization applications, websites, or the like, that may be used for displaying the reports. Likewise, in some embodiments, skill engines may be arranged to integrate with conventional document generators, PDF generators, printers, or the like.

Next, in one or more of the various embodiments, control may be returned to a calling process.

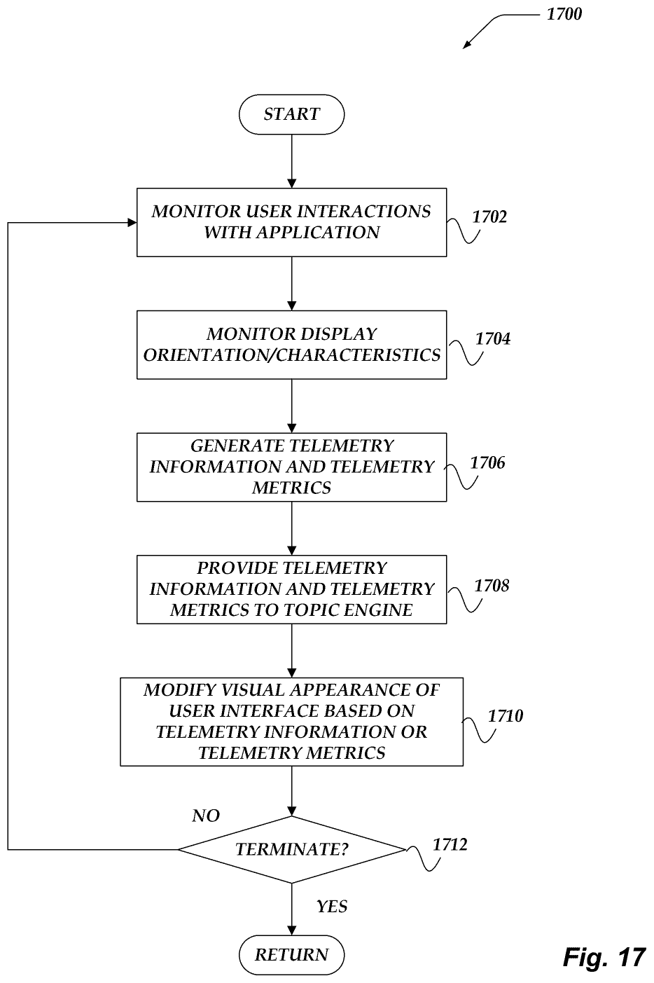

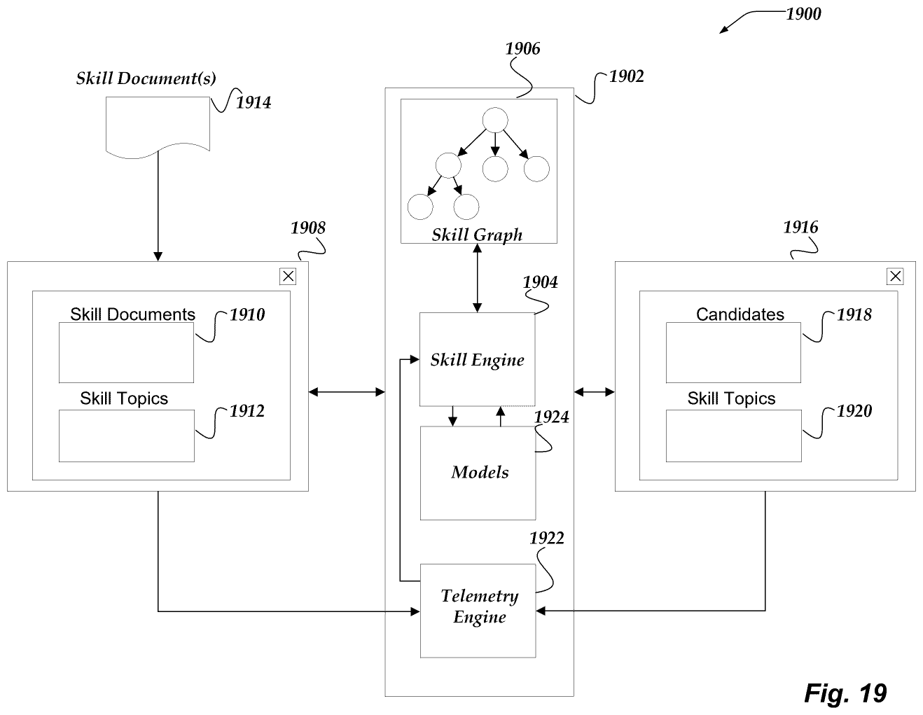

FIG. 17 illustrates a flowchart of process 1700 for collecting and applying telemetry information and telemetry metrics for skill extraction pipelines in accordance with one or more of the various embodiments. After a start block, at block 1702, in one or more of the various embodiments, telemetry engines may be arranged to monitor one or more user interactions with one or more applications. As described herein, telemetry engines may be arranged to monitor or track how users may physically interact with one or more user interfaces associated with the one or more applications. In some embodiments, user interactions may include active interactions associated with user activity or passive interactions associated with user inactivity. Also, in one or more embodiments, various types of collected user telemetry may be based on a user's selection or non-selection of one or more particular elements or content in a display panel, pointing device (mouse) hover time over particular content or elements in a display panel, user dwell time between actions in a display panel, dwell time for viewing a display panel by a user, and the like. Also, in some embodiments, telemetry engines may be arranged to track mouse movement, eye movement, keystrokes, or the like, to determine how users may interact with information displayed in user interfaces. See, description for FIG. 19 for additional details.

At block 1704, in one or more of the various embodiments, telemetry engines may be arranged to monitor one or more display characteristics or display orientation characteristics.

As described above, in some embodiments, telemetry engines may be arranged to monitor various display characteristics employed for displaying the user interfaces, including the size/type of display, screen resolution, screen orientation, number of active displays, screen brightness, refresh rate, aspect ratio, color dynamic range, windowed or full screen modes, or the like. In some embodiments, screens, monitors, or operating systems may provide interfaces or APIs that enable telemetry engines to obtain information about the current state or status of the display screen. In some cases, for some embodiments, operating systems or other services may be configured to actively notify telemetry engines if one or more screen characteristics may change.

At block 1706, in one or more of the various embodiments, telemetry engines may be arranged to generate telemetry information or one or more telemetry metrics. In some embodiments, the monitored interactions or display characteristics may be represented as telemetry information or telemetry metrics. The particular format of the telemetry information or telemetry metrics may vary depending on the type interactions or characteristics being represented. Accordingly, in some embodiments, telemetry information or telemetry metrics may be included in one or more data structures that may be communicated to other applications or services. For example, in some embodiments, telemetry information or telemetry metrics may be represented using key-value pair data structures that include a key field representing the label or type of metric and a value field that represents the value of the metric.

At block 1708, in one or more of the various embodiments, telemetry engines may be arranged to provide the telemetry information and telemetry metrics to a skill engine.

In some embodiments, telemetry engines may be arranged to provide one or more interfaces or APIs that enable other applications or services, such as skill engines, or the like, to gain access to the telemetry information or telemetry metrics. In some embodiments, telemetry engines may be configured to push some or all of the telemetry information or telemetry metrics to one or more subscribing application or services. Also, in some embodiments, telemetry engines may be configured to enable other application or services to poll or otherwise request-on-demand some or all of the telemetry information or telemetry metrics.

At block 1710, in one or more of the various embodiments, skill engines may be arranged to modify the visual appearance of one or more user interfaces based on the telemetry information or telemetry metrics.

Accordingly, in some embodiments, skill engines may dynamically change the visual appearance of the one or more user interfaces to improve the efficiency and effectiveness of the user interfaces based on some or all of the telemetry information or telemetry metrics. For example, skill engines may be arranged to dynamically select, position, size, shape, remove, hide, inactivate, disable, highlight, or style one or more visual user interface components such as display panels, controls, elements, or content based on, among other things, one or more telemetry metrics. For example, if telemetry information or telemetry metrics indicate that users are focusing on or navigating to particular user interface views, components or user interface panels, skill engines may be arranged to highlight or size the preferred user interface elements or display panels. For example, if users are determined to rarely interact with a particular display panel, skill engines may be arranged to reduce the size, diminish the shape, disable its controls, and re-position that display panel to improve the efficiency of display screen usage. See, also FIG. 19 and its description.

At decision block 1712, in one or more of the various embodiments, if the telemetry engine of skill engine may be terminated, control may be returned to a calling process; otherwise, control may loop back to block 1702. In some embodiments, telemetry engines may be arranged to continuously or periodically provide updated/current telemetry information or telemetry metrics to enable skill engines to dynamically change the visual appearance of the one or more user interfaces. Accordingly, in some embodiments, process 1700 may continue operation until it may be explicitly terminated, or the operation of the associated skill engine may be terminated.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

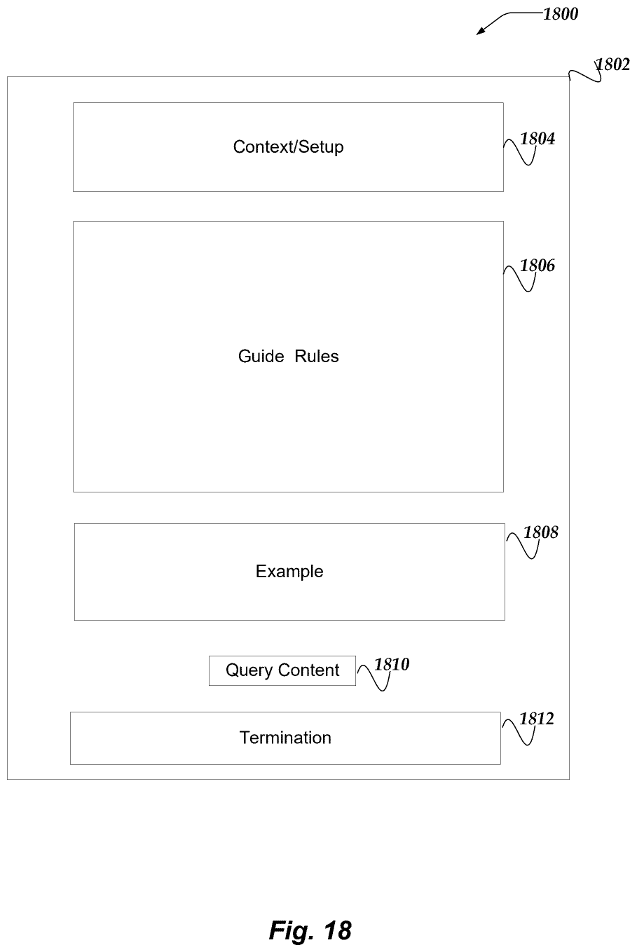

FIG. 18 illustrates a logical schematic of prompt 1800 for skill extraction pipelines in accordance with one or more of the various embodiments. As described above, in some embodiments, skill engines may be arranged to determine a prompt template from among one or more prompt templates. In some embodiments, if a prompt template may be determined and a query statement is provided, skill engines may be arranged to generate a prompt based on the prompt template and the query statement.

One of ordinary skill in the art will appreciate that the particular contents or text included in prompt templates may vary depending on various factors, including, the generative AI model (e.g., different types/version/brands of generative AI models may require different prompt templates), format or content required for desired responses, profiles, or the like. In general prompt templates may be developed experimentally such that prompt templates produce prompts that may be used to train generative AI models to produce responses that conform to the requirements of learner platforms. In some embodiments, prompt templates may be included in a prompt template repository or other data store. In some cases, employing prompts to train a more generalized language model to provide particular results that the language model may not explicitly be trained or tuned for may be referred to as zero-shot learning because the generalized language model (referred to herein as generative AI models) is trained by the prompts in real-time to desired results. Accordingly, in some embodiments, generative AI models that consume prompts may perform transfer learning, or the like, to provide specific results, such as, skill labels, skill label verifications, or the like.

Accordingly, in some embodiments, the particular contents of prompt templates or prompts may depend on the semantic understanding capabilities of the underlying generative AI model. Thus, in some cases, different generative AI models may require different prompt templates. Further, in some embodiments, different generative AI models may be engineered to address different target audiences, problem domains, or the like. Accordingly, in some embodiments, skill engines may be arranged to select among multiple generative AI models depending on the queries, response targets, transaction costs, latency, or the like.

In some embodiments, prompt templates may comprise a dataset container, such as, container 1802 that may hold the contents (e.g., text or audio) for the prompt. Also, in some embodiments, prompt templates may be configured to include various sections, including, for example, context section 1804, guide rule section 1806, example section 1808, query statement placeholder 1810, termination section 1812, or the like. In some cases, for some embodiments, prompt templates may omit one or more sections. Likewise, in some embodiments, prompt templates may include one or more other sections. Further, in some cases, prompt templates may arrange the various sections in a different order than shown here. Thus, in some embodiments, policy engines may be arranged to employ different prompt templates for different problems or different generative AI models as needed.

In one or more of the various embodiments, prompt containers may be variables, parameters, objects, data structures, or the like, that enable the prompts to be passed to a generative AI model. In some cases, for some embodiments, a prompt container may be a buffer of text characters that form a string collection that may be included in the prompts. Likewise, for example, a prompt container may be an object or class instance designed for handling the types of content (e.g., string, audio, or the like) included in a particular prompt.

In one or more of the various embodiments, context sections such as context section 1804 may be portions of a prompt template that inject statements that establish a working context that may aid in the training of the generative AI model to generate learner information. For example, in some embodiments, context sections may be employed to declare skill dialect information, skill information, skill spans, or the like. Accordingly, in some embodiments, generative AI models may incorporate this context information as part of the generative process that produces or evaluates skill information such as skill labels, skill spans, or the like.

In one or more of the various embodiments, guide rule sections such as guide rule section 1806 may be portions of a prompt template that inject one or more statements that may be selected to provide additional guidance or direction for training the generative AI model to generate the desired responses (e.g., skill labels. For example, in some embodiments, guide rules may include statements that declare rules for omitting certain types of punctuation, omitting in-depth explanation text from configuration profiles, directives to specifically or particularly take actions if certain words or text forms are encountered while generating skill labels, or the like.

In one or more of the various embodiments, example sections such as example section 1808 may be a portion of a prompt template that includes one or more examples of the skill information or skill spans that may correspond to the example query statement. In some embodiments, if needed, the example information may guide the training of the generative AI model to generate skill labels that conforms to the requirements of the particular skill dialects or supported organizations.

In one or more of the various embodiments, query statement placeholders such as query statement placeholder 1810 may be specialized tokens, markers, mark-up, or the like, that indicate where in the prompt template that the actual query statement should be embedded in the prompt.

In one or more of the various embodiments, termination sections such as termination section 1812 may be a portion of a prompt template that includes additional context information or guide rules that may be required to “close” the prompts. For example, for some embodiments, termination sections may include a text statement indicating the generative AI model should end the text generation session, or the like.

In some embodiments, learner platforms may be arranged to employ one or more pre-made prompt engineering frameworks that support key words, data definitions languages, formatting, or the like, that enable parameterized prompt generation such that skill engines may be arranged to provide particular parameters or inputs that enable the prompt engineering framework to generate the actual prompts that may be provided to generative AI models.

FIG. 19 illustrates a logical schematic of system 1900 for skill extraction pipelines in accordance with one or more of the various embodiments. System 1900 may comprise various constituents, including: predictive learner platform 1902; skill engine 1904; one or more models, such as models 1924 (skill label models, verification models, skill span models, graph fitting models, embedding models, topic searchers, or the like); skill graph 1906; one or more client user interfaces, such as user interface 1908; one or more operator user interfaces, such as user interface 1916; one or more telemetry engines, such as telemetry engine 1922, or the like.

In some embodiments, user interfaces, such as user interface 1908 or user interface 1916 may include various windows, controls, or other user interface features. In some embodiments, user interfaces may include various user interface panels, such as panel 1910, panel 1912, panel 1918, panel 1920, or the like. For example, in some embodiments, panel 1910 may represent a user interface that enables users, such as learners (or students) or job seekers to upload or review their personal raw skill documents, such as resumes, transcripts, certifications, or the like. Also, for example, panel 1912 may represent a user interface that enables users to review one or more of the skills that may be determined from skills information extracted from their raw skill documents. Likewise, in some embodiments, panels such as panel 1912 may display the skills (if any) that may match the skills determined from their skill documents.

In some embodiments, skill engine 1904 may be arranged to generate or display user interface 1908 to users using one or more of video interface 242, projector 246, display 250, or the like, of a client computer, such as client computer 200. Similarly, in some embodiments, skill engine 1904 may be arranged to generate or display user interface 1916 to users using a one or more of input/output interface 338, display 350, audio interface 356, or the like, of a network computer, such as network computer 300.

Further, in this example, skill documents 1914 may represent a user's skill documents before they are ingested by predictive learner platform 1902. Accordingly, in this example, a user may employ user interface 1908 to upload skill documents 1914 to the predictive learner platform. Also, in some embodiments, predictive learner platform users associated with organizations seeking employment candidates, or otherwise evaluating learners or job seekers based on skills may employ user interfaces such as user interface 1916. Accordingly, in some embodiments, user interfaces such as user interface may include display panel 1918 for reviewing candidates that may be matched with one or more open positions, or the like. Also, in some embodiments, skill engine 1904 may provide display panel 1920 to enable users to evaluate the skills used for matching candidates. In some embodiments, panel 1918 may be arranged to display a rank ordered list of candidates based on the skill graph matching skills associated with the candidates with skills associated with job openings. Accordingly, in some embodiments, candidates that have skills that match more relevant skills than other candidates may be ranked higher than the others. Note, in some embodiments, one of ordinary skill in the art will appreciate that organizations may have significant control or influence over the particular ranking criteria. For example, in some cases, one or more skills may be considered more important than others. Accordingly, in some embodiments, some skills may be associated with different weights depending on the particular jobs or positions.

Similarly, in some embodiments, panel 1920 may be arranged to display skills associated with the matched candidates, associated skill documents, the positions under consideration, or the like. Similar to panel 1912, skills included in panel 1920 may be associated with skills extracted from skill information associated with open positions, matched candidates, or the like.

In some embodiments, job seekers may employ user interface 1908 to upload or select skill documents for consideration. In some embodiments, user interface 1908 may be arranged to provide skill documents 1914 to skill engine 1904. Accordingly, in some embodiments, skill engines may be arranged to employ skill graph 1906 to match skills in the skill documents.

In some embodiments, skill engines may be arranged to collect various telemetry or other metrics associated with user interactions with user interfaces. In some embodiments, telemetry may include tracking or monitoring if users may be in agreement with skill extractions, skill matching, skill extractions, job/position matches, candidate selection, candidate ranking, or the like. In some embodiments, skill engines may be enabled to employ telemetry information or telemetry metrics collected or determined by telemetry engines. In some embodiments, telemetry engines may be separate from skill engines as shown here. Also, in some embodiments, telemetry engines may be part of or otherwise embedded in skill engines.

Also, in one or more embodiments, various types of collected user telemetry may include a user's selection or non-selection of one or more particular elements or content in a display panel, pointing device (mouse) hover time over particular content or elements in a display panel, user dwell time between actions in a display panel, dwell time for viewing a display panel by a user, and the like.

In one or more of the various embodiments, skill engines may be arranged to monitor telemetry information associated with one or more users.

Accordingly, in some embodiments, skill engines may be arranged to provide one or more facilities to collect direct feedback from one or more of the users that may interact with one or more skills or similar information. For example, in some embodiments, user interfaces may include controls that enable authorized users to grade one or more skills matches. Likewise, in some embodiments, a user interface may be provided to grade the candidate-position matches.

In some embodiments, grades or scores may be binary (e.g., like/dislike), discrete (e.g., one-four stars, letter grades), continuous values, or the like.

Also, in one or more of the various embodiments, skill engines may be arranged to provide user interfaces that monitor how users employ skills, skill graphs, or the like. In some embodiments, telemetry information employed to monitor user preferences may be based on monitoring user interactions as well as direct feedback. Accordingly, in some embodiments, skills, skill matches, or the like, that may appear well-formed but are ignored or discarded by users may be inferred to be poorly received. For example, for some embodiments, if the top ranked candidates provided in response to a query, or the like, are ignored or lower ranked candidates are favored by users, it may be inferred that there may be a problem with the matching for the current application.

Further, in some embodiments, skill engines may be arranged to receive telemetry information from other services or applications. Accordingly, in one or more of the various embodiments, skill engines are not required to directly monitor activity associated with the skills. For example, for some embodiments, skills associated user interfaces may be displayed to users via desktop computer applications, mobile applications, web-based applications, or the like. In some embodiments, such applications may collect the telemetry information and provide some or all it to skill engines rather than requiring the skill engines to include monitoring facilities on user-side applications.

Accordingly, in some embodiments, telemetry engine 1922 may be arranged to collect metrics or telemetry associated with user interactions with user interface 1908 using a one or more of input/output interface 238, cameras 240, touch interface 244, keypad 252, audio interface 256, GPS, 258, open air gesture interface 260, haptic interface 264, pointing device interface 266, or the like, of a client computer, such as client computer 200. Similarly, in some embodiments, skill engine 1922 may be arranged to collect metrics or telemetry associated with user interactions with user interface 1916 using a one or more of input/output interface 338, GPS 340, keyboard 352, audio interface 356, pointing device interface 358, or the like, of a network computer, such as network computer 300.

In some embodiments, telemetry engines may be arranged to track mouse movement, eye movement, keystrokes, or the like, to determine how users may interact with information (e.g., skills, skill topics, candidates, skill documents, or the like) displayed in user interfaces. Accordingly, in some embodiments, skill engines may be arranged to evaluate at least the quality of various recommendations, matches, skill extractions, skill graph generations, or the like based on how users interact with them. For example, if users consistently select or otherwise favor candidates ranked lower than others, it may indicate that one or more models performing the ranking or matching may be experiencing diminished or diminishing effectiveness. Likewise, in some embodiments, users may reject or ignore skill matches which may indicate that one or more associated models or systems may be experiencing diminished or diminishing effectiveness.

In some embodiments, skill engines may be arranged to associate a performance score with various models or user interfaces employed for extracting skill topics or generating skill graphs based on the user interaction metrics or telemetry. Accordingly, in some embodiments, if the performance score associated with a model or user interface falls below a defined threshold value, skill engines may be arranged to suspend those particular models or user interfaces from operation. Or, in some embodiments, skill engines may be arranged to automatically modify the deficient user interfaces.

In some cases, for some embodiments, skill engines may be arranged to automatically retrain suspended or otherwise deficient models based on the accumulated metrics/telemetry. Likewise, in some embodiments, skill engines may be arranged to retrain the suspended or otherwise deficient models using additional or updated skill information or skill documents.

Further, in some embodiments, skill engines may be arranged to employ telemetry information collected by the telemetry engines, such as telemetry engine 1922, or the like, for selecting or training models with respect to the geographical location of users. For example, in some embodiments, telemetry metrics may indicate that one or more particular models perform better (based on user telemetry) than others depending on the location of the user.

Also, in some embodiments, telemetry engines may be arranged to collect and determine telemetry information that includes user telemetry, user feedback, and telemetry metrics to dynamically transform user interfaces, display panels, and the like. The dynamic transformation may include arrangement, re-arrangement, elimination, addition, or adaptation of content and visual elements in user interfaces and display panels based on at least the collected telemetry information.

Additionally, in some embodiments, telemetry engines are associated with the one or more user interactions with the predictive learner platform including content within the user interfaces and display panels. In some embodiments, user profiles may be configured to include user interface preferences based on collected user telemetry metrics and user feedback. Accordingly, in some embodiments, skill engines may dynamically change the visual appearance of the user interface to improve the efficiency and effectiveness of the predictive learner platform for the user. The skill engines may be arranged to dynamically select, position, size, shape, remove, hide, inactivate, disable, highlight, or style one or more visual user interface components such as display panels, controls, elements and content based on one or more of user telemetry metrics and user feedback. For example, if users are tracked focusing on or navigating to particular user interface views, components or user interface panels, skill engines may be arranged to highlight or size the preferred user interface elements and/or display panels. For example, if users are determined to rarely interact with a display panel such as display panel 1910, skill engines may be arranged to reduce the size, diminish the shape, disable its controls, and re-position display panel 1910 by displaying a smaller sized greyed out version of display panel 1910 below display panel 1912.

Also, in some embodiments, skill engines may be arranged to adapt user interfaces based on the size/type of display, input methods, user status, or the like. For example, in some embodiments, if a user is determined to be operating using a mobile device, one or more user interface elements may be positioned differently. In some cases, for some embodiments, depending on the display type or display size, one or more user interface elements may be hidden from view.

Further, in some embodiments, skill engines may be arranged to adapt user interfaces based on results generated by verification models, graph fitting models, skill label models, skill extraction models, matching models, or the like. For example, in some embodiments, if a skill graph may be rearranged by repositioning one or more skill nodes in the skill graph, not only may it impact how skills may be matched with the skill graph it may impact how skills, skill labels, or the like, may be displayed to users. For example, in some embodiments, if a graph fitting model, or the like changes the parent skill node for one or more skill nodes in a skill graph, skill engines may be arranged to modify one or more of its user interfaces in view of the updated skill graph. For example, a skill that was previously de-emphasized because it was associated with skill leaf node in the skill graph may be highlighted in user interfaces if it is converted to a parent skill node. Likewise, in some embodiments, if new or additional skills may be extracted from skill documents or other skill information, skill engines may be arranged to adapt user interfaces to highlight the new skills.

Accordingly, in some embodiments, skill engines may be arranged to tangibly modify user interfaces, display panels, interactive reports, input collection, input selection, or the like, based on the efficient and effective performance of processes and/or activities associated with various types of models, including skill label models, verification models, skill span models, graph fitting models, embedding models, topic searchers, skill graphs, or the like as determined by telemetry information, or the like.

What is claimed as new and desired to be protected by Letters Patent of the United States is:

1. A method of managing skill information over a network using one or more processors to execute instructions that are configured to cause actions, comprising:
determining a plurality of skill spans based on skill information associated with one or more job descriptions, wherein each skill span includes one or more words included in the skill information;
generating a comparison of the plurality of skill spans with a plurality of other skill spans, wherein each of the other skill spans is associated with a skill node in a skill graph;
employing an indication by the comparison that one or more skill spans of the plurality of skill spans are unmatched with the plurality of other skill spans to perform further actions, including:
employing a skill label model to generate one or more skill labels based on the one or more unmatched skill spans;
employing a verification model to verify the one or more skill labels based on one or more authoritative sources, wherein the skill label model is retrained with the one or more skill labels that are unverifiable;
employing the retrained skill label model to generate one or more updated skill labels that are verified by the verification model;
generating one or more new skill nodes based on the one or more verified updated skill labels; and
generating information for fitting the one or more new skill nodes in the skill graph, wherein one or more prompts that include the information are used to train a generative artificial intelligence model to generate an updated skill graph that includes the one or more new skill nodes; and
generating a user interface for a report that includes one or more display panels with content that is dynamically transformed and arranged for display to a user based on user telemetry, user feedback and telemetry metrics, wherein the content includes information associated with the updated skill graph and one or more of a control, a result, a graph, or a list associated with the subject matter domain.

2. The method of claim 1, wherein verification of the one or more skill labels, further comprises:
employing the one or more skill labels to query the one or more authoritative sources, wherein the one or more authoritative sources include one or more of a general purpose search engine, a labor specific data source, an industry online journal, a government reference, or an occupational information database.

3. The method of claim 1, wherein generating the one or more skill labels, further comprises:
generating one or more prompts for one or more generative artificial intelligence models, wherein the one or more prompts include the one or more unmatched skill spans; and
training the one or more generative artificial intelligence models with the one or more prompts to determine one or more the skill labels based on one or more responses from the one or more generative artificial intelligence models.

4. The method of claim 1, further comprising:
generating the skill graph based on a plurality of skill nodes, wherein each skill node is associated with a skill label and one or more skill attributes that include one or more of a reference to a skill span, a reference to a raw data source, a reference to learner profile, a reference to a job profile, or a reference to a course profile; and
determining one or more relationships between the plurality of skill nodes, wherein each relationship is an edge in the skill graph, and wherein at least one relationship is represented by a directed edge that corresponds to one or more actions that enable an acquisition of a target skill.

5. The method of claim 1, wherein generating the one or more skill labels, further comprises:
determining one or more skill dialects based on the skill information or a query, wherein each skill dialect is associated with one or more of a labor market, an industry, a training environment, a career field, or a geographic region;
generating one or more prompts for a generative artificial intelligence model based on one or more of the one or more unmatched skill spans or the skill information, wherein the one or more prompts directs the generative artificial intelligence model to conform the one or more skill labels to the one or more skill dialects; and
determining the skill labels based on one or more responses from the one or more generative artificial intelligence models.

6. The method of claim 1, wherein verifying the one or more skill labels, further comprises:
generating one or more prompts for a generative artificial intelligence model based on one or more of the one or more unmatched skill spans or the skill information, wherein the one or more prompts direct the generative artificial intelligence model to verify that the one or more skill labels are consistent with the skill information; and
determining the one or more verified skill labels based on one or more responses from the generative artificial intelligence model.

7. The method of claim 1, wherein comparing the plurality of skill spans with the plurality of other skill spans, further comprises:
generating a plurality of embedding vectors based on the plurality of skill spans, wherein each embedding vector corresponds to a skill span; and
comparing the plurality of embedding vectors with a plurality of other embedding vectors, wherein each of the other embedding vectors is associated with a skill node in the skill graph.

8. The method of Claim1, wherein retraining the skill label model, further comprises:
generating one or more prompts for a generative artificial intelligence model based on one or more unverified skill labels and one or more of the one or more unmatched skill spans or the skill information; and
retraining the skill label model based on a submission of the one or more prompts.

9. A network computer for managing skill information, comprising:
a memory that stores at least instructions; and
one or more processors that execute instructions that are configured to cause actions, including:
determining a plurality of skill spans based on skill information associated with one or more job descriptions, wherein each skill span includes one or more words included in the skill information;
generating a comparison of the plurality of skill spans with a plurality of other skill spans, wherein each of the other skill spans is associated with a skill node in a skill graph;
employing an indication by the comparison that one or more skill spans of the plurality of skill spans are unmatched with the plurality of other skill spans to perform further actions, including:
employing a skill label model to generate one or more skill labels based on the one or more unmatched skill spans;
employing a verification model to verify the one or more skill labels based on one or more authoritative sources, wherein the skill label model is retrained with the one or more skill labels that are unverifiable;
employing the retrained skill label model to generate one or more updated skill labels that are verified by the verification model;
generating one or more new skill nodes based on the one or more verified updated skill labels; and
generating information for fitting the one or more new skill nodes in the skill graph, wherein one or more prompts that include the information are used to train a generative artificial intelligence model to generate an updated skill graph that includes the one or more new skill nodes; and
generating a user interface for a report that includes one or more display panels with content that is dynamically transformed and arranged for display to a user based on user telemetry, user feedback and telemetry metrics, wherein the content includes information associated with the updated skill graph and one or more of a control, a result, a graph, or a list associated with the subject matter domain.

10. The network computer of claim 9, wherein verification of the one or more skill labels, further comprises:
employing the one or more skill labels to query the one or more authoritative sources, wherein the one or more authoritative sources include one or more of a general purpose search engine, a labor specific data source, an industry online journal, a government reference, or an occupational information database.

11. The network computer of claim 9, wherein generating the one or more skill labels, further comprises:
generating one or more prompts for one or more generative artificial intelligence models, wherein the one or more prompts include the one or more unmatched skill spans; and
training the one or more generative artificial intelligence models with the one or more prompts to determine one or more the skill labels based on one or more responses from the one or more generative artificial intelligence models.

12. The network computer of claim 9, wherein the one or more processors execute instructions that are configured to cause actions, further comprising:
generating the skill graph based on a plurality of skill nodes, wherein each skill node is associated with a skill label and one or more skill attributes that include one or more of a reference to a skill span, a reference to a raw data source, a reference to learner profile, a reference to a job profile, or a reference to a course profile; and
determining one or more relationships between the plurality of skill nodes, wherein each relationship is an edge in the skill graph, and wherein at least one relationship is represented by a directed edge that corresponds to one or more actions that enable an acquisition of a target skill.

13. The network computer of claim 9, wherein generating the one or more skill labels, further comprises:
determining one or more skill dialects based on the skill information or a query, wherein each skill dialect is associated with one or more of a labor market, an industry, a training environment, a career field, or a geographic region;
generating one or more prompts for a generative artificial intelligence model based on one or more of the one or more unmatched skill spans or the skill information, wherein the one or more prompts directs the generative artificial intelligence model to conform the one or more skill labels to the one or more skill dialects; and
determining the skill labels based on one or more responses from the one or more generative artificial intelligence models.

14. The network computer of claim 9, wherein verifying the one or more skill labels, further comprises:
generating one or more prompts for a generative artificial intelligence model based on one or more of the one or more unmatched skill spans or the skill information, wherein the one or more prompts direct the generative artificial intelligence model to verify that the one or more skill labels are consistent with the skill information; and
determining the one or more verified skill labels based on one or more responses from the generative artificial intelligence model.

15. The network computer of claim 9, wherein comparing the plurality of skill spans with the plurality of other skill spans, further comprises:
generating a plurality of embedding vectors based on the plurality of skill spans, wherein each embedding vector corresponds to a skill span; and
comparing the plurality of embedding vectors with a plurality of other embedding vectors, wherein each of the other embedding vectors is associated with a skill node in the skill graph.

16. The network computer of claim 9, wherein retraining the skill label model, further comprises:
generating one or more prompts for a generative artificial intelligence model based on one or more unverified skill labels and one or more of the one or more unmatched skill spans or the skill information; and
retraining the skill label model based on a submission of the one or more prompts.

17. A processor readable non-transitory storage media that includes instructions configured for managing skill information in a computing environment, wherein execution of the instructions by one or more processors on one or more network computers performs actions, comprising:
determining a plurality of skill spans based on skill information associated with one or more job descriptions, wherein each skill span includes one or more words included in the skill information;
generating a comparison of the plurality of skill spans with a plurality of other skill spans, wherein each of the other skill spans is associated with a skill node in a skill graph;
employing an indication by the comparison that one or more skill spans of the plurality of skill spans are unmatched with the plurality of other skill spans to perform further actions, including:
employing a skill label model to generate one or more skill labels based on the one or more unmatched skill spans;
employing a verification model to verify the one or more skill labels based on one or more authoritative sources, wherein the skill label model is retrained with the one or more skill labels that are unverifiable;
employing the retrained skill label model to generate one or more updated skill labels that are verified by the verification model;
generating one or more new skill nodes based on the one or more verified updated skill labels; and
generating information for fitting the one or more new skill nodes in the skill graph, wherein one or more prompts that include the information are used to train a generative artificial intelligence model to generate an updated skill graph that includes the one or more new skill nodes; and
generating a user interface for a report that includes one or more display panels with content that is dynamically transformed and arranged for display to a user based on user telemetry, user feedback and telemetry metrics, wherein the content includes information associated with the updated skill graph and one or more of a control, a result, a graph, or a list associated with the subject matter domain.

18. The media of claim 17, wherein verification of the one or more skill labels, further comprises:
employing the one or more skill labels to query the one or more authoritative sources, wherein the one or more authoritative sources include one or more of a general purpose search engine, a labor specific data source, an industry online journal, a government reference, or an occupational information database.

19. The media of claim 17, wherein generating the one or more skill labels, further comprises:
generating one or more prompts for one or more generative artificial intelligence models, wherein the one or more prompts include the one or more unmatched skill spans; and
training the one or more generative artificial intelligence models with the one or more prompts to determine one or more the skill labels based on one or more responses from the one or more generative artificial intelligence models.

20. The media of claim 17, further comprising:
generating the skill graph based on a plurality of skill nodes, wherein each skill node is associated with a skill label and one or more skill attributes that include one or more of a reference to a skill span, a reference to a raw data source, a reference to learner profile, a reference to a job profile, or a reference to a course profile; and
determining one or more relationships between the plurality of skill nodes, wherein each relationship is an edge in the skill graph, and wherein at least one relationship is represented by a directed edge that corresponds to one or more actions that enable an acquisition of a target skill.
